(19) United States
(12) Patent Application Publication
(10) Pub. No.: US 2017/0037653 A1
(43) Pub. Date: Feb. 9, 2017

(54) CLAMPS FOR PANEL-TYPE FENCES

(71) Applicants: Manfred Schopf, Thornbury, Victoria (AU); John Michael Schopf, Thornbury, Victoria (AU)

(72) Inventors: Manfred Schopf, Thornbury, Victoria (AU); John Michael Schopf, Thornbury, Victoria (AU)

(21) Appl. No.: 15/303,691

(22) PCT Filed: Apr. 11, 2015
(86) PCT No.: PCT/AU2015/000208

§ 371 Date: Oct. 12, 2016

(30) Foreign Application Priority Data
Apr. 13, 2014 (AU) 2014901347
Oct. 20, 2014 (AU) 2014904192

(51) Int. Cl. E04H 17/22; E04H 17/16; F16B 2/06; E04F 11/18

(52) U.S. Cl. CPC E04H 17/22; E04F 11/1851; E04H 17/168; E04F 11/1853; E04F 11/1812; E04F 11/1834; F16B 2/06

(57) ABSTRACT

A clamp (300) for use in supporting fence panels (306). The clamp (300) enables adjustment of the tilt of a panel (306) to be supported in the clamp (300) using movable clamp assemblies (364, 365) within the clamp, positionable using a tilt adjuster (screw 348). The adjuster screw (348) and a screw (350) that clamps clamping members (302, 304) of the clamp (300) are located under the supported panel (306) so as to be unobtrusive. Clamps (600, 800) on the same principle are provided which are suitable for different mounting arrangements, including a clamp (800) which can be grouted in place yet enable easy replacement of a broken panel.

### SCOPE OF THE INVENTION

The invention provides a clamp for clamping a panel. The clamp allows adjustment of an angle of tilt of the panel when clamped, relative to a surface on which the clamp is mounted. Panel height adjustment may also be provided in the clamp. Also provided are improved panel-type fences and methods for their erection.

### INTRODUCTION

Fences, barriers and like structures often today comprise panels supported by clamps that are in turn mounted to surfaces or structures. Elevated balconies and walkways, safety fences for swimming pools and similar architectural applications may for example comprise or be provided with panels and supporting clamps. Posts and rails may or may not be provided also, as part of such structures. It is now particularly common to use glass panels in such structures, the material typically being chosen for its transparency and attractive appearance. The present invention is particularly directed to clamps for supporting glass panels in structures or these types, but this is not to preclude the possibility of applications to other panel types and other structures.

In these and other applications, it is usually important that the panels be accurately positioned relative to each other, but this can be difficult and time consuming to achieve. For example, swimming pool safety fences are often formed of glass panels, arranged end to end and supported vertically by clamps, and without any posts, rails or other structures at the panels' upper edges. In such applications, users desire that adjacent panels be neatly aligned with each other, and particularly desire that upper edges of adjacent panels are in alignment, as deviations from alignment are then very visible. If the area on which such a fence is erected (typically of concrete, and possibly with tiles thereon) is not adequately flat, or if the glass panels are themselves not perfectly flat, great skill may be needed to achieve a satisfactory result.

The invention addresses this problem by providing clamps that allow the tilt (and optionally the height) of a panel to be adjusted.

A further problem known in this art is that many clamps, when assembled and installed, have fasteners (for example grub screws) that are visible to an observer. This is aesthetically undesirable for “architectural” applications of panel-type fences and barriers. It is desirable that clamps when installed either have no externally visible fasteners (or other parts relating to adjustments) or that these be as unobtrusive as possible. The invention addresses this problem also.

### DISCLOSURE OF INVENTION

The invention provides a clamp for clamping panels as used in panel type fences, barriers and the like that when mounted on a surface allows adjustment of a tilt angle of a panel clamped in the clamp. Optionally, the height of the panel above the surface may be made adjustable also, independently of the panel tilt adjustment. The invention further provides improved panel-type fences and methods for their erection.

More specifically, in a first aspect, the invention provides a clamp securable to a panel at an edge thereof and comprising:
a first clamp member;
a second clamp member;
a connecting means;
a first clamping assembly
a second clamping assembly
wherein:
in use a first portion of a panel is positioned between the first and second clamping assemblies and a second portion of the panel is positioned between the first and second clamp members;
the first and second clamping assemblies and the first portion of the panel therebetween are held between the first and second clamp members so that when the connecting means draws first and second clamp members towards each other, the first portion of the panel is held between the first and second clamping assemblies; and
the first and second clamping assemblies are movable relative to the first and second clamp members in lateral directions approximately perpendicular to the panel,
so that the first portion of the panel is movable in said lateral directions relative to the second portion of the panel and the panel is tiltable relative to the clamp.

Preferably, the clamp comprises a panel tilt adjuster adapted to move the first and second clamping assemblies in the same lateral directions simultaneously when actuated by a user. This is important, as the advantage of a tilt adjustment is reduced if making the adjustment is difficult, for example due to a need to adjust multiple parts.

In one way of achieving this, the clamp further comprises:
a first slider between the first clamp member and the first clamping assembly which is movable so as to move the first clamping assembly laterally relative to the first clamp member;
a second slider between the second clamp member and the second clamping assembly which is movable so as to move the second clamping assembly laterally relative to the second clamp member; and
said panel tilt adjuster moves said sliders when actuated by a user.

The said first and second sliders when moved by said panel tilt adjuster may slide on ramps comprised in the first and second clamp members respectively, whereby to move the first and second sliders laterally.

The said panel tilt adjuster may comprise a shaft or other member accessible to and rotatable by a user so as to move said first and second sliders.

It is preferred that the shaft (or other member) is accessible through a port that when the clamp is secured on a horizontal surface is under the said edge of the panel. This is because a port located under the edge of a panel clamped in the clamp may be inconspicuous to an observer.

The said shaft (or other member) may be rotatable about an axis substantially parallel to the said edge of the panel.

In addition to the provision for adjusting the tilt of a panel in the clamp, it is desirable to provide a capacity for adjusting the panel height, independently of the capacity to adjust its tilt. To this end, in a preferred form of the clamp, said first clamping assembly can bear against the edge of the panel and is movable in a direction that is substantially perpendicular to the lateral directions and the said edge of the panel, independently of lateral movement of the first clamping assembly, whereby when the clamp is secured on a horizontal surface the height of the panel lower edge can be adjusted.

In one arrangement for providing a panel height adjustment, the first clamping assembly may be threadably engaged by a screw that:
(a) is rotatable by a user to move the first clamping assembly in the said direction that is substantially perpendicular to the lateral directions and the said edge of the panel, and
(b) able to be supported against longitudinal movement relative to the first clamp member.

Preferably, whether or not a panel height adjustment is provided, the connecting means comprises a clamping screw that:
(a) is accessible by a user; and
(b) has a tapered end movable by rotation of the clamping screw through a range of positions between first and second hooks comprised respectively in the first and second clamp members whereby to move throat surfaces of said hooks apart and so draw said first and second clamp members towards each other.

The clamping screw may be rotatable within a nut that is held captive between the first and second clamp members.

The clamping screw may be rotatable about an axis that is approximately parallel to the said edge of the panel. Although not essential, the clamping screw may be coaxial with an axis of rotation of the panel tilt adjuster, when the panel tilt adjuster contains a rotatable shaft (or other member).

The clamping screw may be accessible by a user through a port that when the clamp is secured on a horizontal surface lies under the said edge of the panel. As with the provision of a panel tilt adjuster access port that lies under the said edge of the panel, this arrangement can have the advantage of being inconspicuous to an observer.

Providing a way to connect two clamp members together in which a screw or the like is inconspicuously located as disclosed herein is specifically considered an invention in itself, whether combined with provision of a panel tilt adjustment and/or height adjustment or not.

The connecting means may lie between the said edge of the panel and mutually opposing contact surfaces of the first and second clamp members whereby the contact surfaces provide a fulcrum for relative rotation between the first and second clamp members as the connecting means is actuated by a user to clamp the panel.

Preferably, the first and second clamping assemblies each comprise a resilient pad and in use of the clamp bear each of said resilient pads bears against the panel.

The resilient pad secured to the first clamping assembly respectively may be integrally formed with a resilient pad that is secured to the first clamp member.

Also, the resilient pad secured to the second clamping assembly respectively may be integrally formed with a resilient pad that is secured to the second clamp member.

There is also provided, as a further invention, a clamp securable to a panel at an edge thereof and comprising:
a first clamp member comprising first clamping surfaces;
a second clamp member comprising second clamping surfaces;
a screw comprising a tapered portion;
wherein:
in use of the clamp, a panel including an edge thereof is positioned between the first and second clamping surfaces;
between firstly a further surface of the first clamp member and a further surface of the second clamp member which further surfaces abut each other and secondly the clamping surfaces said screw is advanced so that said tapered portion is screwed into a space between first and second hooks comprised respectively in the first and second clamp members so as to pull the clamp members together, against the panel; and
the screw has its longitudinal axis substantially parallel to the said edge of the panel.

In a further aspect, the invention provides a fence comprising a panel supported at an edge thereof by a clamp as disclosed herein.

In a still further aspect, the invention provides a method for supporting a panel including the steps of:
providing a clamp adapted to clamp the panel and secured to a surface or structure;
placing the panel in the said clamp; and
clamping the panel in the said clamp,
wherein the clamp is a clamp as disclosed herein.

The method may further comprise the step adjusting at least one of an angle of tilt of the panel and the height of a lower edge of the panel placed in the clamp before the step of clamping the panel in the clamp.

Additional features and details of the invention are described in the following description of preferred embodiments, by reference to the attached diagrams.

In this specification, the word “comprise”, and words and phrases derived therefrom including “comprises”, “comprised”, “comprising”, “comprised of” and “comprised in”, when applied to integers and steps, are intended to indicate the presence of those integers or steps, but not to preclude the possible presence of other integers or steps.

### BRIEF DESCRIPTIONS OF THE VIEWS OF THE DRAWINGS

FIG. 1 is a perspective view of a portion of a panel-type fence to which clamps according to the invention are applicable;

FIG. 2 is a schematic view in cross section of a clamp according to the invention holding a panel vertically, the section being taken on a plane perpendicular to the panel;

FIG. 3 is a schematic view in cross section of the clamp shown in FIG. 2, holding a panel at an angle to vertical and the section being taken on a plane perpendicular the panel;

FIG. 4 is a perspective view of a clamp according to the invention;

FIG. 5 is a first side view of the clamp shown in FIG. 4, as seen looking in the direction of arrow “A”;

FIG. 6 is a front view of the clamp shown in FIG. 4, as seen looking in the direction of arrow “C”;

FIG. 7 is a second side view of the clamp shown in FIG. 4, as seen looking in the direction of arrow “B”;

FIG. 8 is a cross-sectional view of a portion of the clamp shown in FIG. 6, with some detail omitted, the section being taken at the station “8-8”;

FIG. 9 is a cross-sectional view of a portion of the clamp shown in FIG. 6, with some detail omitted, the section being taken at the station “8-8”;

FIG. 10 is a cross-sectional view of the clamp shown in FIG. 6, with some detail omitted, the section being taken at the station “8-8”;

FIG. 11 is a cross-sectional view of the clamp shown in FIG. 6, with some detail omitted, the section being taken at station “8-8”;

FIG. 12 is a cross-sectional view of the clamp shown in FIG. 6, with some detail omitted, the section being taken at station “8-8”;

FIG. 13 is a cross-sectional view of the clamp shown in FIG. 6, with some detail omitted, the section being taken at station “8-8”;

FIG. 14 is a perspective view of a component of the clamp shown in FIG. 4;

FIG. 15 is a further perspective view of the clamp component as shown in FIG. 14;

FIG. 16 is a view from below of the clamp component shown in FIG. 14, with some detail omitted;

FIG. 17 is a side elevation of the component shown in FIG. 14, looking in the direction of arrow “E”;

FIG. 18 is a front elevation of the component shown in FIG. 14, looking in the direction of arrow “D”;

FIG. 19 is a side elevation of the component shown in FIG. 14, looking in the direction of arrow “F”;

FIG. 20 is a perspective view of a further component of the clamp shown in FIG. 4;

FIG. 21 is a side elevation of the component shown in FIG. 20, looking in the direction of arrow “G”;

FIG. 22 is a front elevation of the component shown in FIG. 20, looking in the direction of arrow “J”;

FIG. 23 is a side elevation of the component shown in FIG. 20, looking in the direction of arrow “H”;

FIG. 24 is a perspective view of a slider of the clamp shown in FIG. 4;

FIG. 25 is an elevation of the slider shown in FIG. 24, looking in the direction of arrow “K”;

FIG. 26 is an elevation of the slider shown in FIG. 24, looking in the direction of arrow “L”;

FIG. 27 is an elevation of the slider shown in FIG. 24, looking in the direction of arrow “M”;

FIG. 28 is a perspective view of a further slider of the clamp shown in FIG. 4;

FIG. 29 is an elevation of the slider shown in FIG. 28, looking in the direction of arrow “O”;

FIG. 30 is an elevation of the slider shown in FIG. 28, looking in the direction of arrow “P”;

FIG. 31 is an elevation of the slider shown in FIG. 28, looking in the direction of arrow “N”;

FIG. 32 is a perspective view of an assembly of certain components only of the clamp shown in FIG. 4;

FIG. 33 is a perspective view of an assembly of certain components only of an alternative embodiment of the clamp shown in FIG. 4;

FIG. 34 is a cross-sectional view of the clamp shown in FIG. 6, the section of the clamp being taken at station “34-34”, and the clamp being shown secured to a structure;

FIG. 35 is a magnified view of a portion “Q” of FIG. 34;

FIG. 36 is a perspective view of a baseplate adapted for use with the clamp shown in FIG. 4;

FIG. 37 is an elevation of the baseplate shown in FIG. 36, looking in the direction of arrow “R”;

FIG. 38 is an elevation of the baseplate shown in FIG. 36, looking in the direction of arrow “S”;

FIG. 39 is a perspective view of the clamp shown in FIG. 4, now secured to a baseplate;

FIG. 40 is an elevation of a resilient pad assembly of the clamp shown in FIG. 4;

FIG. 41 is a perspective view of a clamp member, clamping plate and resilient pad assembly of the clamp shown in FIG. 4;

FIG. 42 is an elevation of an alternative resilient pad assembly;

FIG. 43 is an elevation of an assemblage of certain components only of the clamp shown in FIG. 4, as they would be seen looking in the direction of arrow “A”;

FIG. 44 is an elevation of the assemblage shown in FIG. 43, looking in the direction of arrow “T”;

FIG. 45 is an elevation of the assemblage shown in FIG. 44, looking in the direction of arrow “U”;

FIG. 46 is a perspective view of the clamp shown in FIG. 4, now with an anchor secured thereto;

FIG. 47 is a perspective of one clamp member of the clamp and anchor shown in FIG. 46, with a member connecting them omitted;

FIG. 48 is a cross-sectional view through the clamp and anchor shown in FIG. 46, mounted to a slab structure, the section being taken at the station marked 34-34 in FIG. 6;

FIG. 49 is a perspective view of an assembly of the clamp member and anchor shown in FIG. 47 together with a dummy clamp member secured thereto;

FIG. 50 is a perspective view of an assembly of the clamp member and anchor shown in FIG. 47 together with an alternative dummy clamp member secured thereto;

FIG. 51 is a perspective view of an alternative embodiment of the clamp member shown in FIG. 14;

FIG. 52 is a further perspective view of the clamp member shown in FIG. 51;

FIG. 53 is a perspective view of a clamping screw of the clamp shown in FIG. 4;

FIG. 54 is an end view of the clamping screw shown in FIG. 53;

FIG. 55 is a side elevation of the clamping screw shown in FIG. 53;

FIG. 56 is a cross-sectional view of an anchor as shown in FIG. 48, the section being taken at station 56-56.

FIG. 57 is a perspective view of a further clamp according to the invention.

FIG. 58 is a perspective view of a first clamp member of the clamp shown in FIG. 57, together with some additional components of that clamp;

FIG. 59 is a perspective view of a second clamp member of the clamp shown in FIG. 57;

FIG. 60 is a side view of the clamp shown in FIG. 57 grouted into a concrete structure, the concrete structure being shown in cross section;

FIG. 61 is an elevation of the first clamp member shown in FIG. 58, without the additional components shown in FIG. 58, as seen looking in the direction of arrow “A”;

FIG. 62 is a perspective view of a further clamp according to the invention;

FIG. 63 is a front elevation of the clamp shown in FIG. 62;

FIG. 64 is a side view of the clamp shown in FIG. 62;

FIG. 65 is a further perspective view of the clamp shown in FIG. 62;

FIG. 66 is a side view of the clamp shown in FIG. 62, shown grouted into a concrete structure, the concrete structure (but not the clamp) being shown in cross section;

FIG. 67 is a cross-sectional view of the clamp (only) shown in FIG. 66, the section being taken at station “67-67”, the clamp being shown in outline only;

FIG. 68 is a perspective view of a portion of a clamp member of the clamp shown in FIG. 62;

FIG. 69 is is a side view of a portion of the clamp member shown in FIG. 68;

FIG. 70 is a front view of the clamp member shown in FIG. 68;

FIG. 71 is a side elevation of a further clamp as disclosed herein.

### DETAILED DESCRIPTION OF PREFERRED EMBODIMENTS

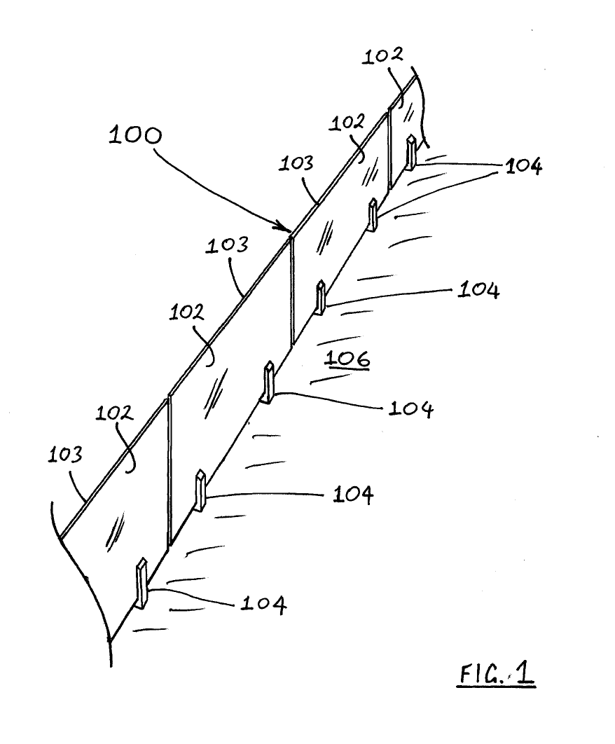

FIG. 1 shows a fence 100 comprising panels 102 arranged end-to-end and each held in a vertical plane by clamps 104 secured on a ground mass 106. Such fences are provided for example as safety fences for swimming pools, and in that application panels 102 are typically of glass, chosen for its transparency and attractive appearance. However other materials (for example certain plastics) may be used in panel-type fences or barriers. Fences of similar construction are known also in buildings, both internally (for example on mezzanine floors) and externally (for example on balconies). Panel-supporting clamps (not shown) of such fences may be mounted to concrete slabs, with or without coverings such as tiles, or timber decks or metal (for example steel) structural members.

The panel-supporting clamps disclosed below are suitable for applications such as these. Their application will for convenience be described by reference to the support of vertical glass panels from below and usage of terms such as “up”, “down”, “above”, “below”, “height” and “laterally” are to be interpreted on this basis. However, it is to be understood that other applications, panel materials and panel orientations may also be found suitable.

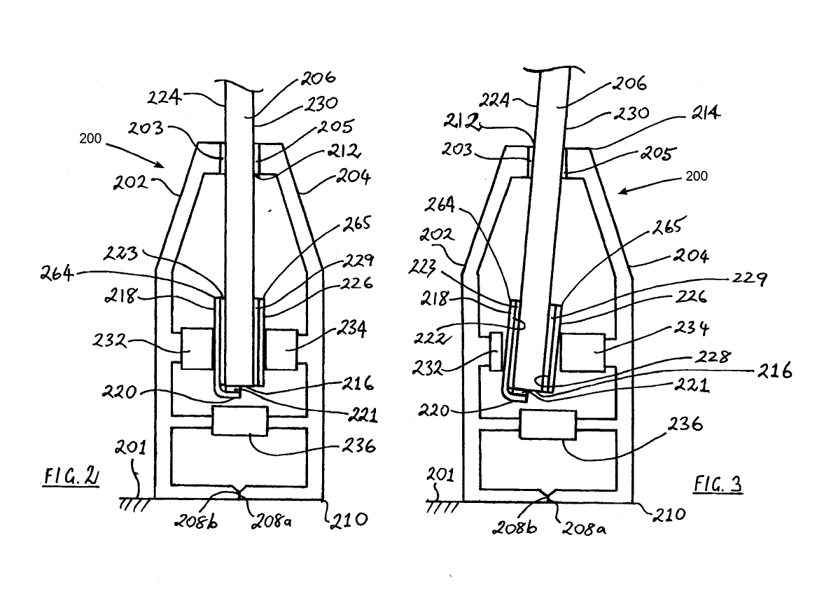

FIGS. 2 and 3 are schematic diagrams provided to show the basic arrangement of the clamps according to the invention which are disclosed herein. These figures show a clamp 200 which comprises a first clamp member 202 and a second clamp member 204. When assembled together the clamp members 202 and 204 can clamp between them a panel 206. Clamp 200 and panel 206 are shown in cross-section the section being in a plane perpendicular to the panel 206.

Clamp members 202 and 204 respectively have contact surfaces 208a and 208b that abut each other, at a bottom end 210 of clamp 200. Panel 206 extends downwardly through a gap 212 at an upper end 214 of clamp 200 and has a lower edge 216.

Associated with clamp member 202 is a first clamping plate 218, having a ledge 220 with a resilient pad 221 thereon which supports lower edge 216 of panel 206, and a face 222 with a resilient pad 223 thereon which presses against a first face 224 of panel 206. Associated with clamp member 204 is a second clamping plate 226 which has a face 228 with a resilient pad 229 thereon that presses against a second face 230 of panel 206.

Clamping plates 218 and 226 are held between a first portion of panel 206 and the first and second clamp members 202 and 204, respectively, by spacing mechanisms 232 and 234, respectively. Spacing mechanism 232 transmits force between clamping plate 218 and clamp member 202 and allows adjustment of the lateral distance between first clamping plate 218 and clamp member 202 (i.e. left or right in FIGS. 2 and 3). Similarly, spacing mechanism 234 transmits force between second clamping plate 226 and clamp member 204 and allows adjustment of the lateral distance between clamping plate 226 and clamp member 204.

Connecting clamp members 202 and 204 is a connecting means 236, located above contact surfaces 208(a and b) and below the clamping plates 218 and 226.

Clamp members 202 and 204 have resilient pads 203 and 205, respectively, thereon, where a second portion of panel 206 passes through gap 212 between clamp members 202 and 204. Together clamping plate 218 and resilient pad 223 comprise a first clamping assembly 264, and together clamp member 226 and resilient pad 229 comprise a second clamping assembly 265.

In use of the clamp 200, the panel 206 is first placed between resilient pads 223 and 229, between pads 203 and 205, and on resilient pad 221. Then, spacing mechanisms 232 and 234 are adjusted to ensure that the panel 206 will be clamped at the desired angle of tilt, and the connecting means 236 is operated to draw and then hold the clamp members 202 and 204 together. Clamp members 202 and 204 act as opposing levers, with a fulcrum provided by contact between contact surfaces 208a and 208b, and clamping forces applied to the panel 206 through pads 203, 205, 223 and 229 balanced by tension in connecting means 236.

FIG. 2 shows panel 206 held perpendicular to a surface 201 on which the clamp 200 is located, and FIG. 3 shows panel 206 held tilted away from the vertical, this being achieved by adjustment of spacing mechanisms 232 and 234. Specifically, in FIG. 3, the first and second clamping assemblies 264 and 265 have been moved left from their positions as shown in FIG. 2, so that panel 206 is tilted and its upper edge (not shown) moves right. Similarly, by moving clamping assemblies 264 and 265 to the right of their positions as shown in FIG. 2, panel 206 can be tilted so that its upper edge (not shown) moves left.

In a first form of clamp 200, connecting means 236 is adjustable to provide a desired level of tension between clamp members 202 and 204 and therefore of clamping forces applied to panel 206 through pads 203, 205, 223 and 229.

Alternatively, in a second form of clamp 200, connecting means 236 may be arranged so that clamp members 202 and 204 are held in fixed relative positions (subject to contact between them at the contact surfaces 208(a and b)). The amount of clamping force on panel 206 and the tension in connecting means 236 will then be determined by the degree of stiffness and the positioning of the resilient pads 203, 205, 223 and 229 and the extent to which they are squeezed when connecting means 236 is operated.

The first of these two forms of clamp 200 has the advantage that in the event of loosening (due for example to ageing of the resilient pads 203, 205, 223 and 229), connecting means 236 can be operated again to restore the desired clamping forces, without necessarily having to replace the pads 203, 205, 223 and/or 229.

For either of these two forms of clamp 200, the distribution of clamping forces applied to the panel 206 through resilient pads 203 and 205 on the one hand, and through resilient pads 223 and 229 on the other hand, will depend on the distances between the first and second clamping plates 218 and 226 and between the clamp members 202 and 204 at the gap 212. For ease of application by a user, it is preferred to provide for both spacing mechanisms 232 and 234 to be able to be adjusted simultaneously by a single action of a user. Means for achieving this will be disclosed below.

The height of lower edge 216 of panel 206 above surface 301 may be increased or reduced by adjustment of the height of ledge 220. Means for making such an adjustment are not shown for clamp 200, but will be disclosed in respect of clamp 300, disclosed below.

Actual embodiments of clamps according to the invention will now be described.

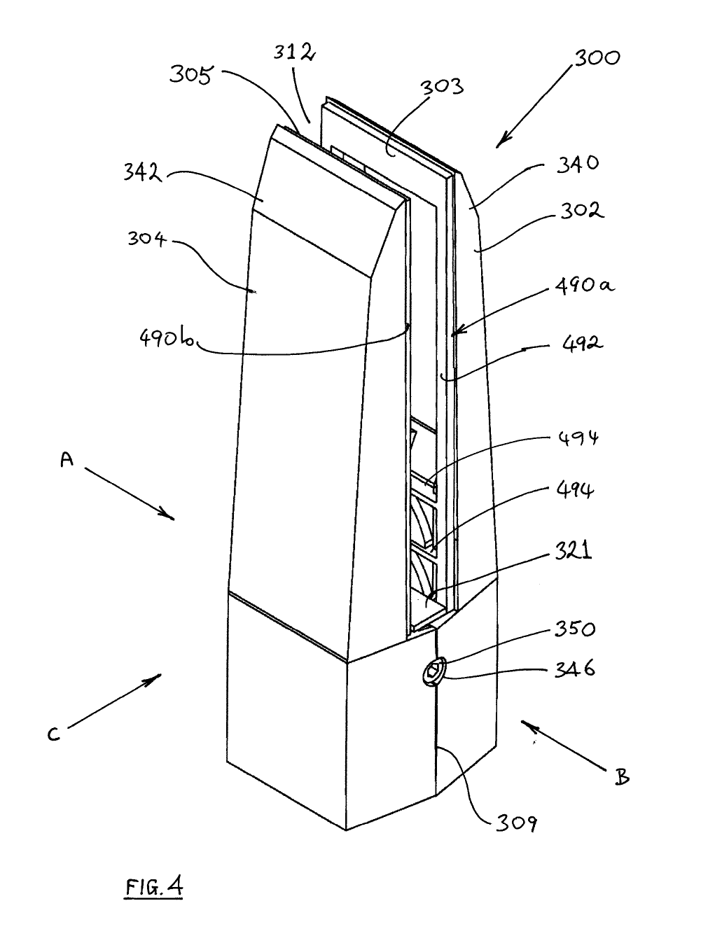

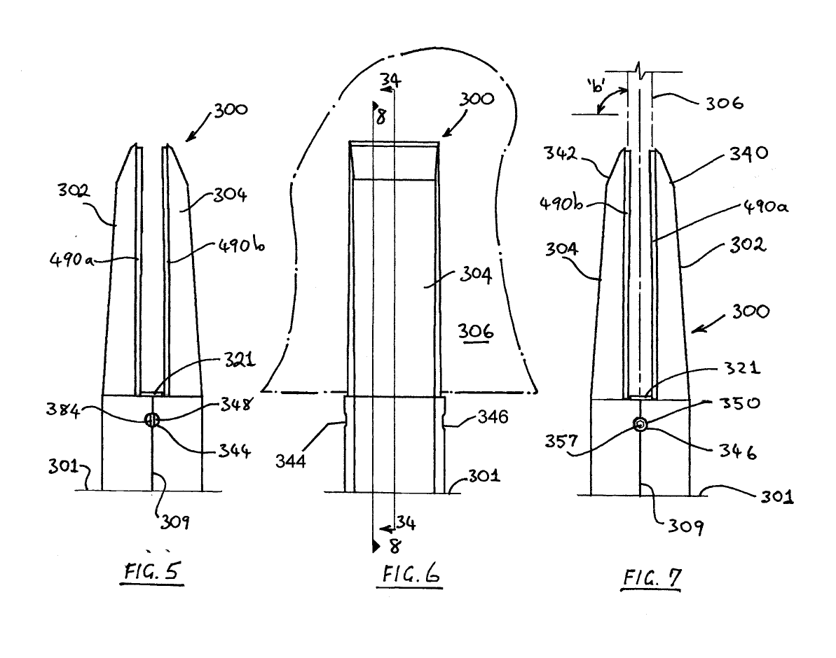

FIG. 4 shows in perspective view a clamp 300 according to the invention. Clamp 300, now mounted on a surface 301, is shown also in FIGS. 5, 6 and 7. A rear view (not shown) of clamp 300 would be substantially identical to the front view of FIG. 6. For convenience of description below of clamp 300, in particular for interpretation of orientation-dependent words such as “upper” and “lower”, the assembled clamp will be assumed to be oriented as it would be when used to support a panel 306 in a vertical plane, by its horizontal lower edge 316, above a horizontal surface 301.

Clamp 300 includes first and second clamp members 302 and 304. A glass panel 306 is able to be placed and clamped in a gap 312 between upper portions 340 and 342 of clamp members 302 and 304, with its lower edge 316 supported on a resilient pad 321 that in turn overlies ledge 320. Glass panel 306 is shown in chain-dotted lines in FIGS. 6 and 7 only, and for clarity in FIG. 7 no attempt has been made to show the deflections that would in practice occur in resilient pads 303 and 305 (secured to clamp members 302 and 304) or in resilient pad 321.

Clamp 300 has first and second side access ports 344 and 346 that respectively allow a user to access a panel tilt adjuster 348 and a clamping screw 350. The location of access ports 344 and 346 is beneath the bottom edge 316 of panel 300 when clamped in clamp 300, and is intended to be much less obtrusive to an observer than if they were located on other external surfaces visible on clamp 300.

In use of the clamp 300, the tilt adjuster 348 allows an installer to adjust to a small degree the angle “b” (see FIG. 7) between the panel 306 and surface 301 on which clamp 300 is secured, in a manner set out below. Normally angle “b” is intended to be 90 degrees, but being able to adjust this angle to slightly higher or lower than 90 degrees, for example between about 89 degrees and 91 degrees, can be of great assistance to installers. Referring to FIG. 1, adjusting the tilt of panels 102 in fence 100 can simplify achieving alignment of the top edges 103 of panels 102 if the ground mass 106 is slightly uneven, if clamps 104 are not precisely in line with each other, or if the panels 102 are not precisely flat. Accurate upper edge alignment is considered highly desirable in frameless, rail-less glass fences such as are used around swimming pools and in high-quality architectural applications. Even in a panel fence with a rail secured at or near the top edges of its panels (not shown), close alignment of the panels' top edges is also desirable.

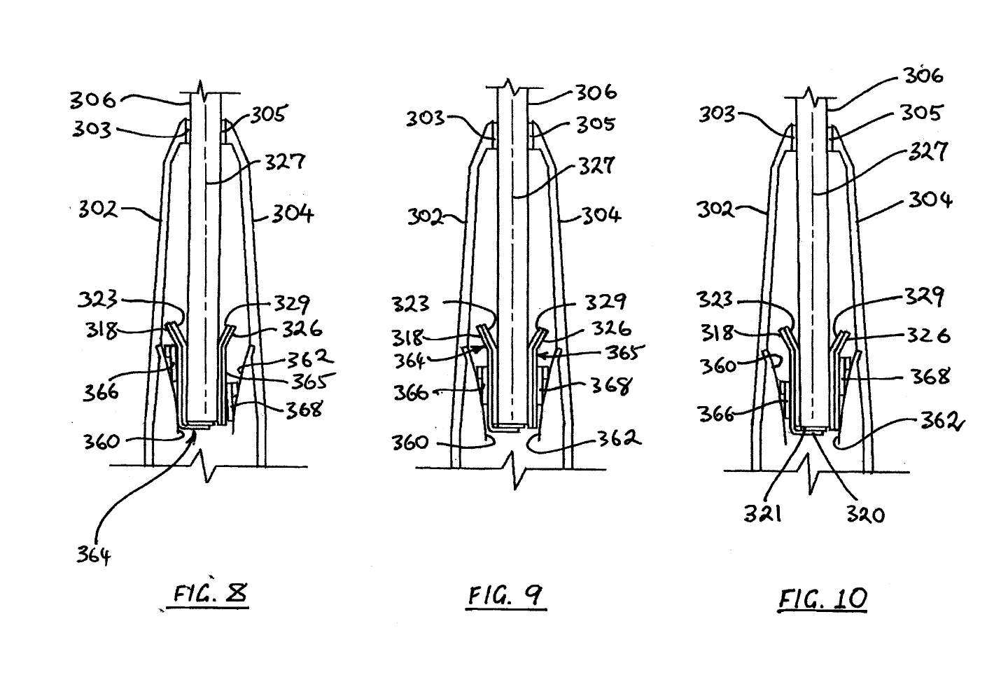

The adjustment of tilt angle using tilt adjuster 348 of panel 306 is carried out with panel 306 placed in clamp 300, and then clamping screw 350 is tightened to complete the clamping of panel 306. How this functionality is achieved is set out below by reference firstly to FIGS. 8, 9 and 10.

Each of FIGS. 8, 9 and 10 shows a portion only of clamp 300 as seen in cross-section taken at the station “8-8” shown in FIG. 6, but is schematic, in that some mechanical detail has been omitted for clarity and ease of understanding. Certain elements in FIGS. 8, 9 and 10 correspond to elements in FIGS. 2 and 3 and are numbered with their element numbers being the same as in FIGS. 1 and 2 with 100 added, so that, for example, clamp members 302 and 304 in FIGS. 8, 9 and 10 correspond to clamp members 202 and 204 in FIGS. 2 and 3. The elements numbered in this way are 300, 302, 303, 304, 305, 306, 316, 318, 320, 321, 323, 326, 329, 364 and 365. The functions of these elements are therefore as described above for their corresponding elements in FIGS. 2 and 3. Note that clamping assembly 364 comprises clamping plate 318 and resilient pad 323 and clamping assembly 365 comprises clamping plate 326 and resilient pad 329.

To allow adjustment of the position of clamping plates 318 and 326 relative to clamp members 302 and 304, clamp 300 has a set of ramps 360 comprised in clamp member 302 and a set of ramps 362 comprised in clamp member 304, and two sliders 366 and 368. Slider 366 can slide upwards and downwards (as drawn in FIGS. 8, 9 and 10) on ramps 360 and slider 368 similarly can slide up and down on ramps 362. Ramps 360 and 362 face each other, and the distance between them increases progressively with increasing height. FIG. 9 shows sliders 366 and 368 positioned at the same height, with panel 306 positioned between pads 323 and 329. With sliders 366 and 368 in these positions relative to clamp members 302 and 304 respectively, as clamp members 302 and 304 are moved inwardly panel 306 is clamped in a vertical position (assuming clamp 300 is mounted on horizontal surface 301 (not shown in FIGS. 8, 9 and 10)).

However, if slider 366 is moved lower on ramps 360 and slider 368 is moved higher on ramps 362, the clamping plates 318 and 326 and pads 323 and 329, that is, clamping assemblies 364 and 365, move to the right as drawn in FIG. 10. The effect is that lower edge 316 of panel 306 is moved right also so that panel 306 is tilted. That part of panel 306 above pads 303 and 305 tilts to the left. As clamp members 302 and 304 are drawn together, the panel 306 is clamped in such a tilted position. Chain dotted line 327 represents a plane that is parallel to, and positioned midway through the thickness of, panel 306 when panel 306 is in a vertical position (as in FIG. 9) and is shown also in FIGS. 9 and 10 to make clearer the effect of this tilt adjustment.

Conversely, as shown in FIG. 8, if slider 366 is moved upwards on ramps 360 from the position shown in FIG. 9, and slider 368 is moved downwards from the position shown in FIG. 9, the clamping plates 318 and 326 and pads 323 and 329, that is, clamping assemblies 364 and 365, move to the left. In this case, as clamp members 302 and 304 are drawn together that part of panel 306 above pads 303 and 305 tilts right. Again, as clamp members 302 and 304 are drawn together, the panel 306 is clamped in a tilted position, as can be seen by reference to chain-dotted line 327.

Clamping plate 318 is prevented from moving excessively upwards during panel tilt adjustment by the panel 306 itself bearing on pad 321 and by screw 354 as described below. Desirably, clamping plate 326 is prevented from moving excessively upwards during panel tilt adjustment by a stop 333 comprised in clamp member 304. (See FIG. 20.)

In this way, ramps 360 and 362, and sliders 366 and 368 together amount to the “spacing mechanisms” 232 and 234 of clamp 200. To illustrate how the sliders 366 and 368 are movable together, FIGS. 11, 12 and 13 show the same cross-sectional views of clamp 300 as FIGS. 8, 9 and 10 respectively, with resilient pads 303 and 305 (and resilient pad assemblies 490, described below, in which they are comprised) omitted for clarity but otherwise without omission of mechanical detail (and now without truncation of the clamp 300 at its lower end).

In effect, sliders 366 and 368 are placed between clamp member 302 and clamping assembly 364 on one hand and between clamp member 304 and clamping assembly 365 on the other hand to adjust the positions of clamping assemblies 364 and 365 relative to the clamp members 302 and 304 and panel 306. However, it is to be noted that different parts of the sliders 366 and 368 can contact the clamping assemblies depending on their relative positions (for example slider 366 can contact clamping plate 318 at edges 396 or 398 or on surface 394).

Comprised in sliders 366 and 368 are push rods 370 and 372 respectively that extend downward (as the clamp 300 is drawn in FIGS. 11, 12 and 13). Panel tilt adjuster 348 comprises a shaft 374 and radial spokes 376 and 378. (See also FIG. 32.) Spokes 376 and 378 extend through openings 380 and 382 in push rods 370 and 372. Shaft 374 is rotatable and supported between clamp members 302 and 304, and extends in a direction substantially parallel to the lower edge 316 of panel 306 when panel 306 is held in clamp 300 (i.e. normal to the page as drawn). Notwithstanding that FIGS. 11, 12 and 13 are cross sections, the whole of (i.e. not a cross-section of) shaft 374 is shown in these Figures, so that a screwdriver slot 384, on the end of shaft 374 is visible.

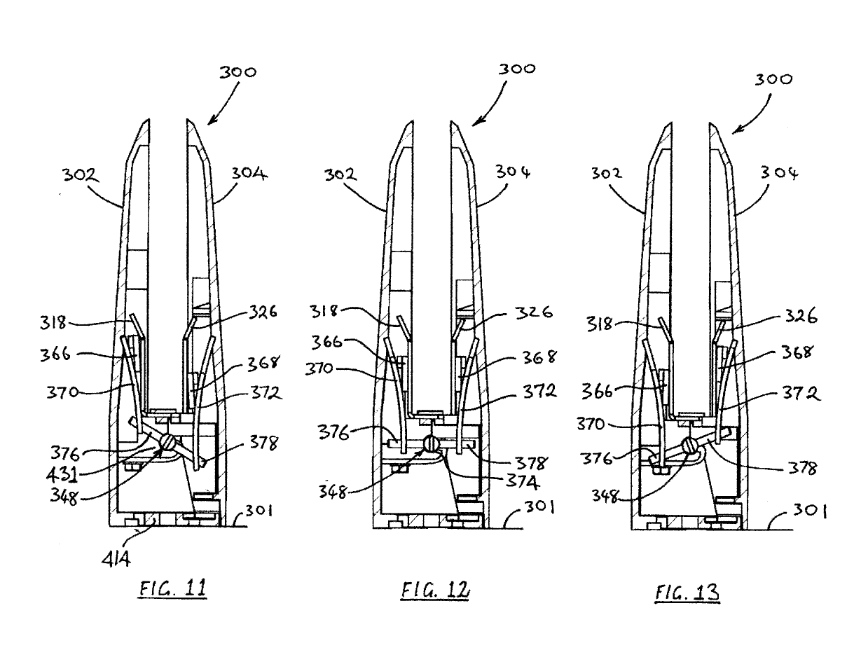

FIG. 12 shows panel 306 in a neutral position (corresponding to FIG. 9) in which the panel 306 is held perpendicular to the surface 301 on which it is mounted. When shaft 374 is rotated clockwise (as drawn in FIG. 11) using a screwdriver (for example) in slot 384, spokes 376 and 378 move too, so that slider 366 moves up on ramps 360 and slider 368 moves down. The effect is that lower edge 316 of panel 306 (not shown in FIG. 11) moves left and panel 306 tilts so that its upper edge (not shown) moves right. In a corresponding manner, counter-clockwise movement of panel tilt adjuster 348 (as drawn in FIG. 13) causes lower edge 316 of panel 306 moves right and its upper edge (not shown) moves left.

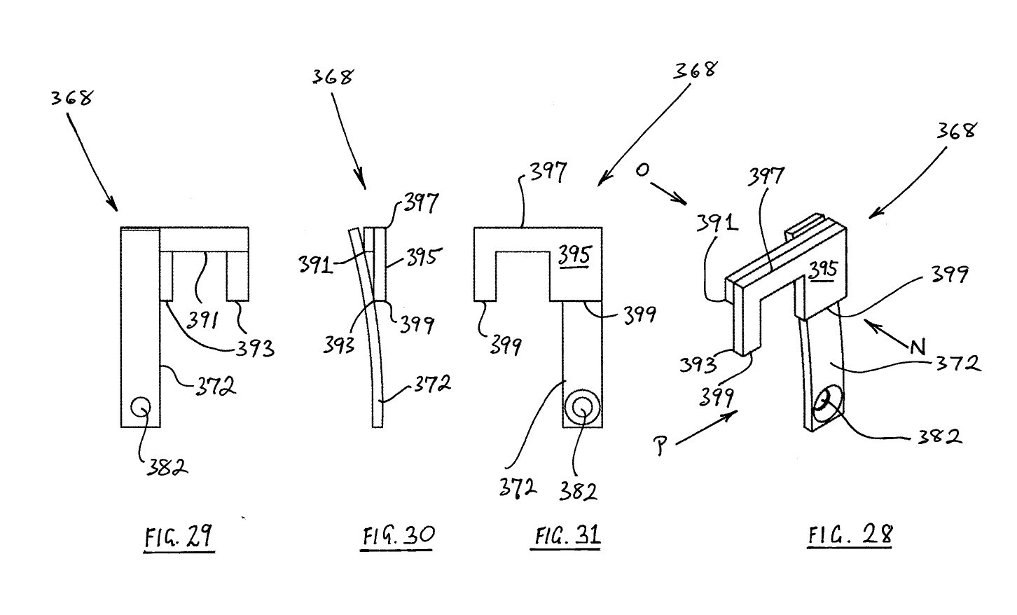

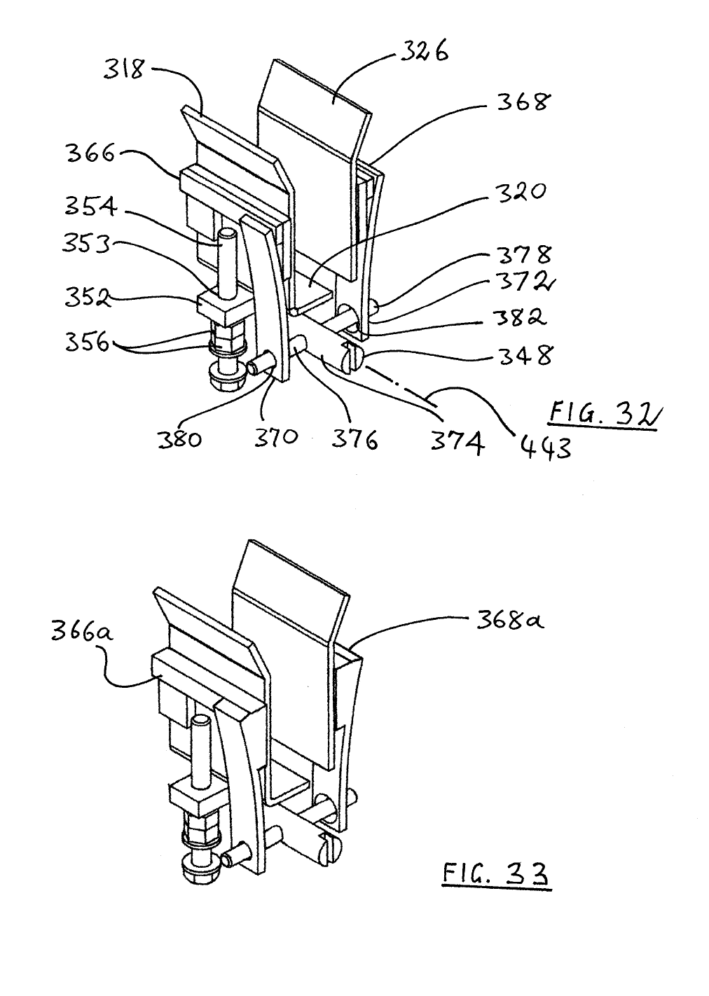

Clamp member 302 is shown in FIGS. 14 to 19 inclusive. Clamp member 302 (and clamp member 304) may each suitably be made as a single unit, for example by investment casting in a suitable metal such as stainless steel. The slider 366 that in clamp 300 slides on ramps 360b and 360c (also collectively referred to herein as ramps 360) of clamp member 302 is shown in FIGS. 24 to 27 inclusive and can be seen in FIG. 32.

Slider 366 is shown in FIGS. 24 to 27 as comprising push rod 370 together with two plates 386 and 388, all welded together (welds are not shown) with plates 386 and 388 together defining first and second slider edges 390 and 392 and a face 394 with edges 396 and 398. Edges 390, 392, 396 and 398 are parallel to each other and in assembled clamp 300 extend substantially parallel to the lower edge of the panel 306 when held in clamp 300. In assembled clamp 300, edges 390 and 392 slide on ramps 360b and 360c. Push rod 370 passes through an opening 402 in clamp member 302 and slides on two guide ramps 400a and 400b. Guide ramps 400a and 400b ensure that slider 366 is prevented from moving in any way other than up and down on ramps 360.

Depending on the relative positions of slider 366 and clamping plate 318, clamping plate 318 is contacted by slider 366 on edges 396 or edges 398 or by surface 394. It has been found that slider 366, when made in the way described above and shown in the Figures, can be so proportioned that either edge 396 or edges 398 is reasonably close to a central vertical position (when the clamp 300 is vertical as drawn) on clamping plate 318.

Ramps 360 and push rod 370 are circularly arcuate (relative to a common centre axis, not shown, that is parallel to the length of shaft 374) firstly for compactness, so that clamp member 302 can be reasonably compact yet provide for sufficient adjustment range of panel tilt adjustment, and secondly so that spoke 376 passes through opening 380 of push rod 370 at a radius from shaft 374 that does not vary as much as would be necessary if ramps 360 were straight. This reduces the variation in the torque required to rotate tilt adjuster 348 through its possible range of angles and so eases the process of adjusting panel tilt. Opening 380 in push rod 370 is tapered along its length, having a larger diameter on the side of push rod 370 that faces shaft 374 than on the side that faces away from shaft 374, to accommodate relative movement between spoke 376 and push rod 370. Spoke 376 passes through opening 380 with some free play. (Similarly, opening 382 in push rod 372 is tapered in the same sense as can be seen in FIGS. 28 to 31 and spoke 378 passes through opening 382 with some free play.)

Shaft 374 of panel tilt adjuster 348 is supported for rotation about an axis 443 partly on part-cylindrical surfaces 404 and 406 of clamp member 302.

Ramps 360 are accommodated in a recess 408 formed in upper portion 340 of clamp member 302 for lightness. It will be noted that the ramps 360b and 360c and 400a and 400b act structurally to stiffen upper portion 340 of clamp member 302 against bending loads applied through resilient pad 303, which is secured to a surface 410 at its upper end.

Clamp member 304 is shown in FIGS. 20 to 23 inclusive. The slider 368 that in clamp 300 is associated with clamp member 304 is shown in FIGS. 28 to 31 inclusive. Sliders 366 and 368 can be made as a handed pair, as shown in FIGS. 24 to 27 and 28 to 31. Edges 391, 393, 397 and 399 and surface 395 of slider 368 function in the same way in relation to ramps 362 and clamping plate 326 as edges 390, 392, 396 and 398 and surface 394 function in relation to ramps 360 and clamping plate 318.

Corresponding to ramps 360b and 360c of clamp member 302 in clamp member 304 and located in a recess 409 are similarly arcuate ramps 362b and 362c, collectively referred to as ramps 362, and corresponding to guide ramps 400a and 400b are guide ramps 401a and 401b. Push rod 372 of slider 368 slides on guide ramps 401a and 401b and passes downwardly through an opening 403 in clamp member 304. Below opening 403, spoke 378 passes through opening 382 in push rod 372 (see FIG. 32). The arcuate shapes of ramps 362b and 362c, guide ramps 401a and 401b, and push rod 372 of slider 368 are adopted for the same reasons as the arcuate shapes of ramps 360b and 360c, guide ramps 400a and 400b and push rod 370.

In addition to surfaces 404 and 406 of clamp member 302, shaft 374 of shaft 374 of panel tilt adjuster 348 is supported for rotation on part-cylindrical surface 405 of clamp member 304.

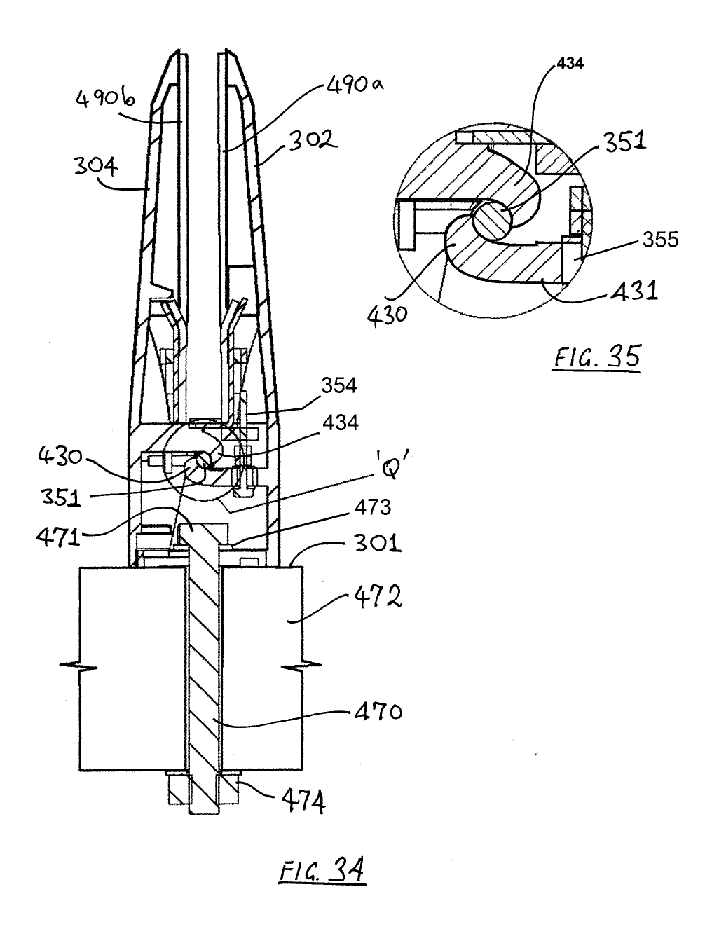

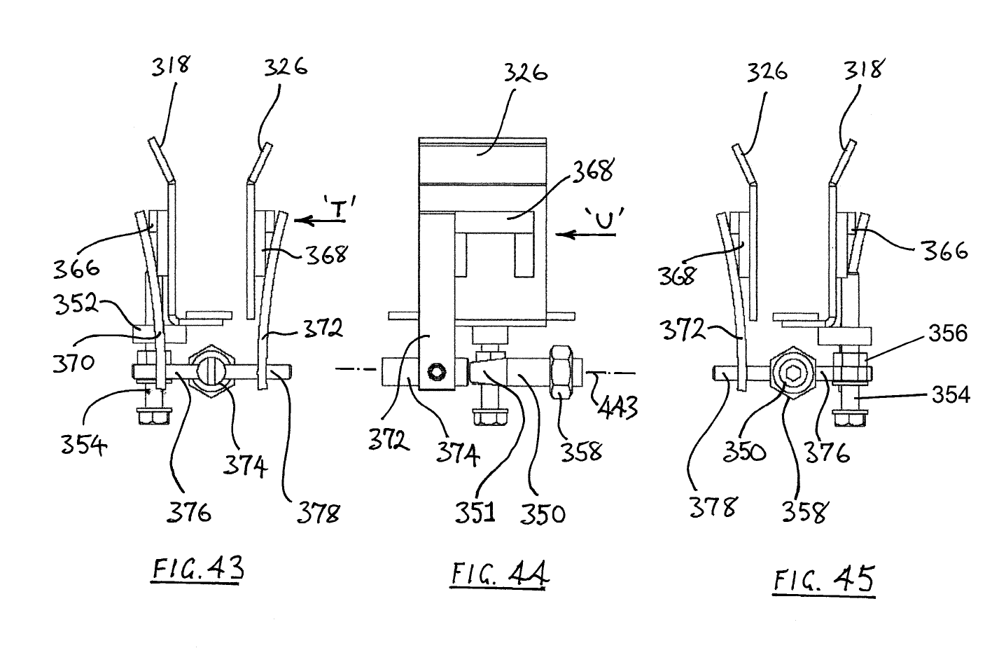

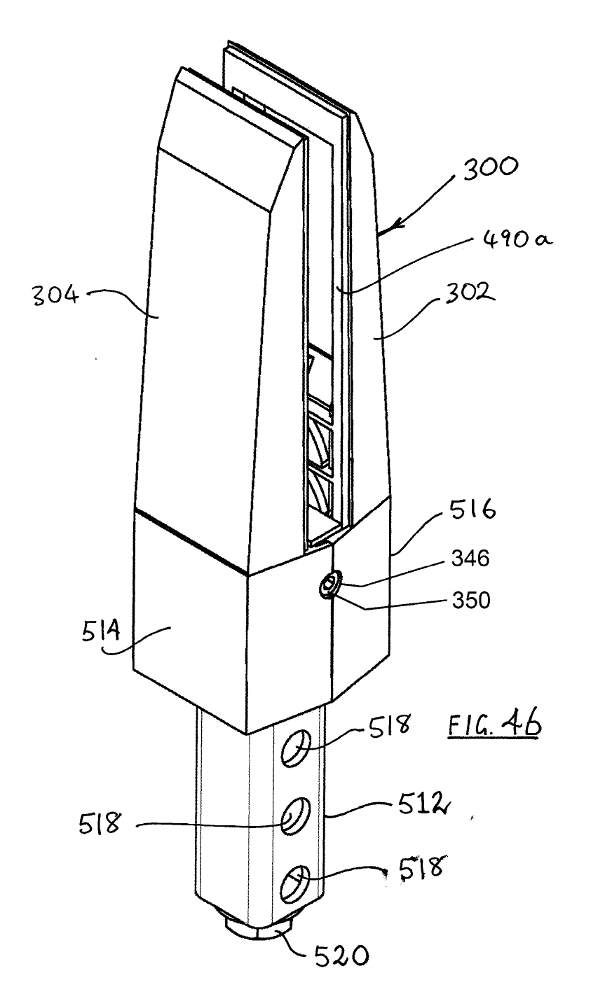

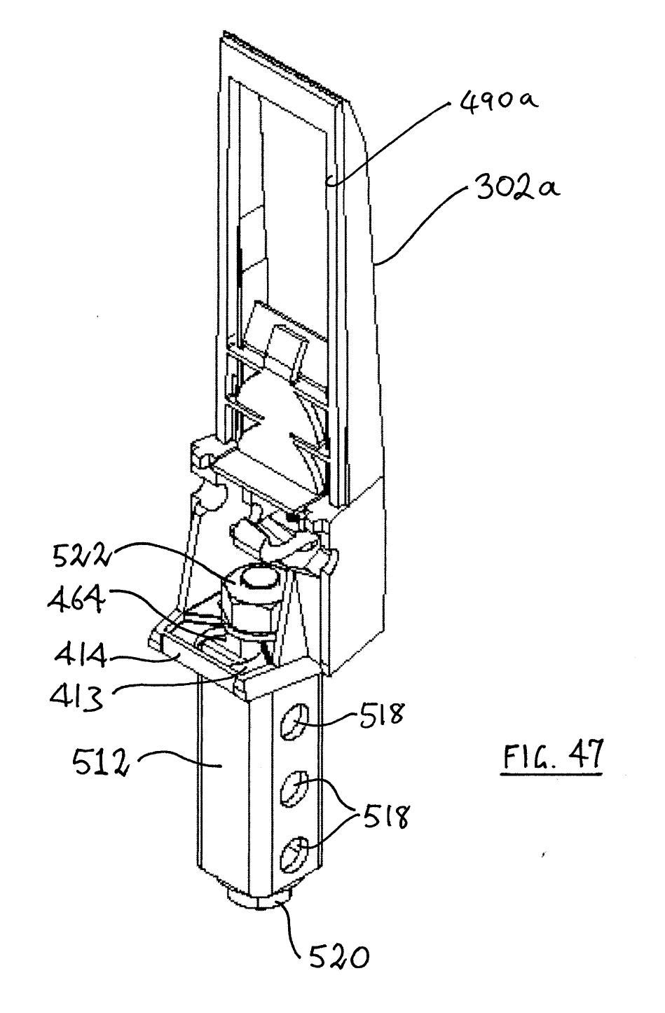

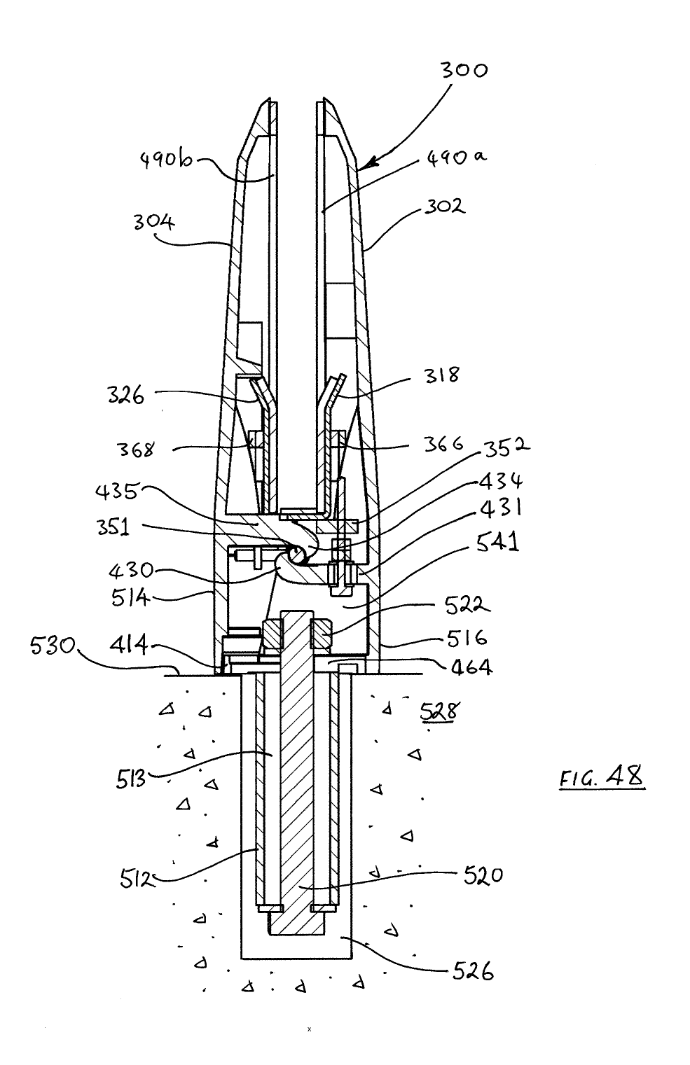

FIG. 32 is a perspective view showing clamping plates 318 and 326, sliders 366 and 368, and panel tilt adjuster 348, in the positions they occupy relative to each other in assembled clamp 300. As can also be seen in FIG. 32, clamping plate 318 has a projecting formation 352 with a threaded hole 353 therein, in which is received a screw 354. In clamp 300, screw 354 is received in a slot 355 in a pillar formation 431 comprised in clamp member 304, as can be seen in FIGS. 14 and 35. Slot 355 is elongate in a direction perpendicular to the plane of a panel 306 when held in clamp 300 so as to allow movement of screw 354 and the clamping plate 318 during adjustment of the tilt of panel 306. FIG. 32 shows clearly that clamping plates 318 and 326 are bent outward at their upper ends to provide for easier positioning of panel 306 between them. FIGS. 43, 44 and 45 show the same components as FIG. 32, plus clamping screw 350 and nut 358, described below, all in the positions they occupy relative to each other in assembled clamp 300.

Nuts 356 engaged on screw 354 in use lock screw 354 onto pillar formation 431. The height of clamping plate 318 above the surface 301 to which clamp 300 is mounted can be adjusted up or down by suitable positioning of nuts 356 on screw 354 and rotation of screw 354 in formation 352. As ledge 320 comprised in clamping plate 318 supports panel 306, such adjustment also raises or lowers panel 306. This adjustment is independent of the panel tilt adjustment.

Clamp member 302 has a base member 414 of plate-like form by which it can be secured to a substrate such as surface 301. In the assembled clamp 300, base member 414 is received between side walls 416 and 418 of clamp member 304, and surfaces 408a on base member 414 contact surfaces 408b of clamp member 304. Surfaces 308a on base member 414 correspond to contact surfaces 208a of clamp 200, and surfaces 308b on clamp member 304 correspond to contact surfaces 208b of clamp 200, so that in assembled clamp 300 contact between surfaces 308a and 308b provides a fulcrum about which clamp members 302 and 304 rotate very slightly while being progressively pressed against panel 306 therebetween during the clamping process.

Next, the way in which clamp members 302 and 304 are drawn and held together to clamp the panel 306 therebetween, is described, i.e. the practical realization of the “connecting means” 236 of the idealized clamp 200 described above.

Clamp member 302 comprises a hook 430 on a pillar 431 by which hook 430 is secured to the remainder of clamp 302. (When clamp member 302 is a casting, hook 430 and pillar 431 are preferably integrally cast parts of clamp 302). Corresponding to hook 430 and pillar 431 of clamp member 302, clamp member 304 comprises a hook 434 on a pillar 435. Hook 434 and pillar 435 are also preferably integrally cast parts of clamp member 304. In clamp 300, both hook 430 and hook 434 extend partway circumferentially around (that is to say hook on to) a longitudinally tapered end portion 351 of the clamping screw 350 at the same location therealong, which end portion 351 in use is positioned between, and in contact with, inwardly facing throat surfaces 432 and 436 of hooks 430 and 434 respectively. Throat surfaces 432 and 436 are shaped as parts of conical or approximately conical surfaces so as to be urged apart thus bringing clamping plates 318 and 326 towards each other as tapered end portion 351 moves inwardly between them, with contact between surfaces 308a and 308b providing a fulcrum for slight relative rotation between clamp members 302 and 304.

Note that the in assembled clamp 300, the clamp members 302 and 304 come closely together below their upper portions 340 and 342. To allow for relative rotation of clamp members 302 and 304 about the fulcrum provided by their abutting contact surfaces 308a and 308b, there are small gaps 309 between clamp members 302 and 304. Although in the Figures gap 309 appears only as a line because it is narrow, it actually tapers slightly, being wider at the top than the bottom. (Note: In the alternative embodiment mentioned above, having a fixed distance between the two clamp members 302 and 304, gap 309 may instead be closed completely or substantially so.)

Threadably engaged with clamping screw 350 is a hexagonal nut 358. When clamp 300 is assembled, nut 358 is received in recesses 440 and 441 of clamp members 302 and 304 respectively. Recesses 440 and 441 are shaped to hold nut 358 captive between clamp members 302 and 304 in assembled clamp 300 and to prevent rotation of nut 358.

FIGS. 43, 44 and 45 show the clamping screw 350 and nut 358 in the position relative to other components that they occupy in clamp 300 in use. Note that clamping screw 350 is shown as being coaxial with axis 443 of shaft 374 of panel tilt adjuster 348. This is preferred but not essential.

An end 357 of clamping screw 350 is accessible to a user through second side access port 346 of clamp 300. Clamping screw 350 is shown in FIGS. 53, 54 and 55 and has a hexagonal socket 349 for an “Allen” key, and a threaded portion 359. During assembly of clamp 300, clamp members 302 and 304 are brought together, so that nut 358 becomes captive between them, in recesses 440 and 441. Clamping screw 350 is engaged in nut 358 and screwed inwardly so that its tapered end portion 351 advances towards hooks 430 and 434 and into contact with their respective throat surfaces 432 and 436. Throat surfaces 432 and 436 are approximately part-conically shaped and so oriented that as clamping screw 350 advances inwardly of clamp 300, its end portion 351 pushes throat surfaces 432 and 436 apart, and in turn clamp members 302 and 304 are drawn together at the vertical position in clamp 300 of hooks 430. With contact surfaces 308a and 308b in contact to act as a fulcrum for slight relative rotation of clamp members 302 and 304, the result is that upper portions 340 and 342 of clamp members 302 and 304 come together to clamp panel 306 therebetween. FIG. 34 shows clamp 300 in cross section, mounted on a structural member 472 having the surface 301. FIG. 35 is a detail from FIG. 34, magnified to show hooks 430 and 436 engaged with the end portion 351 of clamping screw 350.

It is important, when clamp members 302 and 304 are brought together to clamp panel 306, that they be in accurate registration with each other. Therefore, clamp member 302 has two locating formations 438 that, as clamp members 302 and 304 are brought together, are received close-fittingly within two recesses 439 in clamp member 304. This firstly ensures that clamp members 302 and 304 are at substantially the same location as each other in a direction along the length of the lower edge 316 of panel 306. However, in addition, angular misalignment of clamp members 302 and 304 (i.e. in which surfaces 410 and 412 of clamp members 302 and 304 are out of registration with each other even when the clamp members are in registration elsewhere) is also avoided as follows. Recesses 439 have upward facing surfaces 437 against which locating formations 438 bear as end portion 351 of clamping screw 350 forces apart the throat surfaces 432 and 436 of hooks 430 and 434. This is because hooks 430 and 434 are positioned between (as well as below) formations 438.

This arrangement, in which two clamp members 302 and 304 are kept in both longitudinal (i.e. along the length of a panel edge) and angular alignment by having two spaced-apart locating formations (such as 438) that are close-fittingly received in, and that in use bear against on upwardly or downwardly facing surfaces (such as 437) of, cooperating recesses (such as 439) is considered an invention in itself, independently of the panel tilt adjustment capability.

To avoid damage to clamped panel 306, resilient pads 303 and 305 are secured (for example using a suitable adhesive) on surface 410 of clamp member 302 and surface 412 of clamp member 304 respectively. Resilient pads 323 and 329 are similarly secured on clamping plates 318 and 326 respectively for the same reason. In addition, resilient pad 321 is provided on ledge 320 of clamping plate 318 to protect and cushion the lower edge 316 of panel 306. All resilient pads referred to herein may conveniently be made of suitable vulcanized natural rubber or synthetic rubber, although the use of suitable resilient plastics materials is not precluded.

Edge surfaces 445 of clamp member 302 and edge surfaces 447 of clamp member 304 are desirably also padded to avoid damage to panel 306, to prevent ingress of water or solid matter between panel 306 and clamp members 302 and 304, and for improved appearance. This can be done by additional and separate resilient pads (not shown) sized and shaped for securing on surfaces 445 and 447.

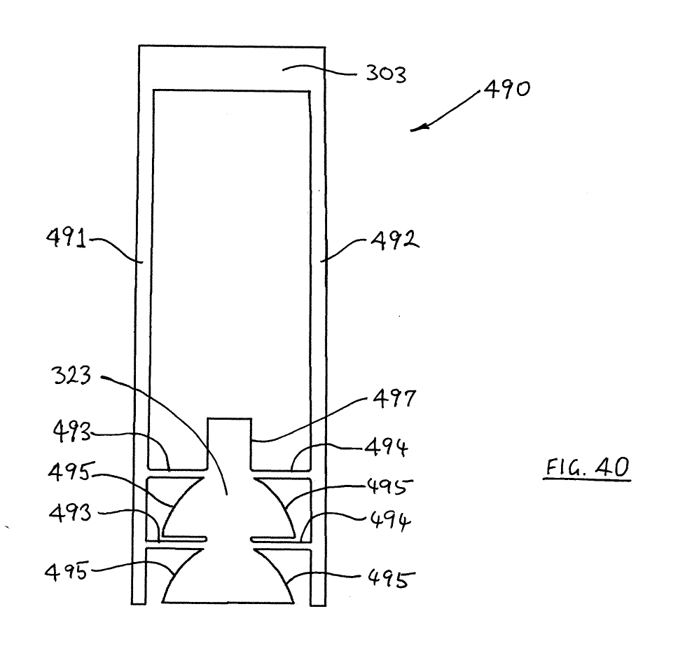

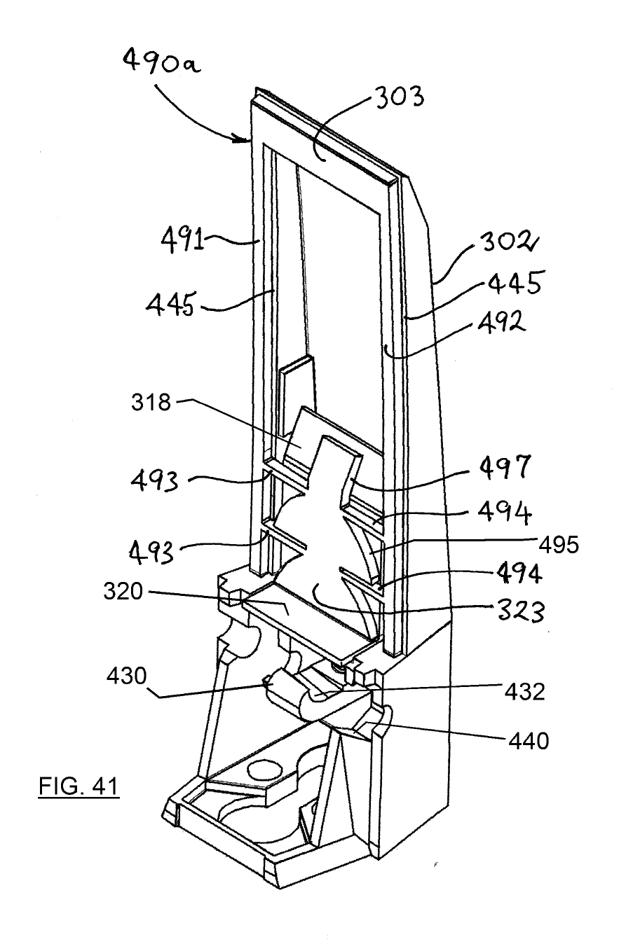

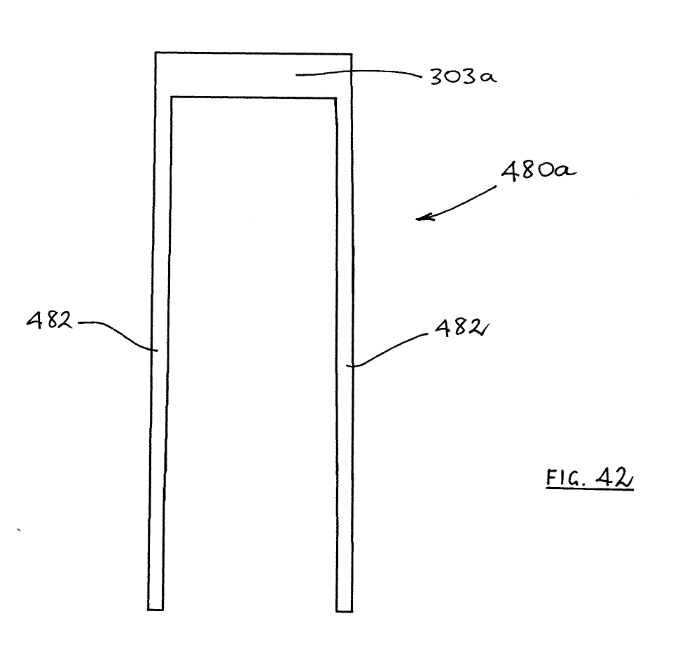

However the padding arrangement of clamp 300, which gives a lower count of separate parts, and is thought more convenient in actual manufacture and/or use, will now be described, by reference to FIGS. 40 and 41. FIG. 40 shows a single resilient pad assembly 490a cut from a sheet of resilient material (of any of the types mentioned above as suitable for resilient pads and preferably of constant thickness). FIG. 41 shows resilient pad assembly 490a secured in position on clamp member 302. Resilient pad assembly 490a comprises as integral parts thereof, the resilient pad 303, and two legs 491 and 492. Resilient pad 303, as mentioned earlier, is in clamp 300 secured to face 410, and legs 491 and 492 are secured to edge surfaces 445, of clamp member 302.

Also comprised in resilient pad assembly 490a as integral parts thereof are the resilient pad 323, that in clamp 300 is secured to clamping plate 318, and elongate arms 493 and 494. Elongate arms 493 and 494 connect resilient pad 323 to legs 491 and 492 respectively. Resilient pad assembly 490a can be conveniently manufactured by being cut or punched from a sheet of appropriate resilient material with one stroke of a shaped die, which is convenient. Elongate arms 493 and 494 can contact, but are not secured to any part of, clamp member 302.

The elongate arms 493 and 494 are narrow and able to flex and stretch as necessary so that resilient pad 323 can move up (towards resilient pad 303) independently of legs 491 and 492, as the height of clamping plate 318 is adjusted. So that resilient pad 323 can cover a sufficient area of clamping plate 318, yet allow enough flexing and stretching of elongate arms 493 and 494, resilient pad 323 has curved edges 495 which elongate arms 493 and 494 can wrap partially around when clamping plate 318 and resilient pad 323 are adjusted as high as they can go. (Note that adequate resistance of resilient pad 323 to excessive thinning under clamping pressures depends on a suitably high ratio of surface area to length of periphery. The shape shown in FIG. 40 assists in the obtaining of such a ratio.)

An upper portion 497 of resilient pad 323 is in use secured to an upper part 499 of clamping pate 318 that is bent outwards to ease the movement of panel 306 downwards through gap 312 into clamp 300.

Generally, when resilient pad assembly 490a is used, resilient pad 321 will be a separate item. Resilient pad assembly 490a can be extended downward (not shown) so as to also comprise resilient pad 321, however, depending on the material used for resilient pad assembly 490a, the sharp corner between clamping plate 318 and ledge 320 may make this impractical.

A resilient pad assembly 490b, identical to resilient pad 490a, is used on clamp member 304, to provide the functions of resilient pads 305 and 329, and to pad surfaces 447.

Note that resilient pad assembly 490a is shown in an unloaded condition, in which, elongate arms 493 and 494 are straight. In an alternative embodiment (not shown) of resilient pad assembly 490a, elongate arms 493 and 494 are made to have a curved shape when in an unloaded condition, to reduce the amount of stretching required of them during upward movement of pad 323.

In still another alternative embodiment, a resilient pad 480a (shown in FIG. 42) may be used on clamp member 302. Resilient pad 480a comprises a portion 303a securable to face 410 of clamp member 302 and which serves the same purpose as resilient pad 303, described above. Integral with and depending from portion 303a are two legs 482 that can be secured on edge surfaces 445 of clamp member 302. Resilient pad 480a can be cut from a single sheet of resilient pad material (as described above for resilient pad assembly 490a). In the preferred arrangement where the surfaces 412 and 447 of clamp member 304 are identical to surfaces 410 and 445 of clamp member 302, a resilient pad 480b, identical to resilient pad 480a, may be used on clamp member 304, the portion 303a then having the function of resilient pad 305. Otherwise a resilient pad (not shown) similar in general arrangement to resilient pad 480a, but sized and proportioned to suit the geometry of clamp member 304 could be used. Separate resilient pads 321, 323 and 329 are also required when resilient pads 480a and 480b are used in clamp 300 as an alternative to resilient pad assemblies 490a and 490b.

In use, the clamp 300 is assembled, secured in place (for example on the structural member 472, as shown in FIG. 34) and a panel 306 is placed loosely between the clamp members 302 and 304. Any necessary tilt adjustment is then made using panel tilt adjuster 348, before clamping screw 350 is fully tightened to clamp panel 306.

Arrangements and methods for mounting the clamp 300 to structures and substrates will now be described.

Clamp 300 may be mounted directly on a structural member 472 (or surface such as 301) that is sufficiently rigid and strong to withstand the forces transmitted to it by the combination of clamp 300 and a panel 306 clamped therein. FIG. 34 shows one way of doing this. A single bolt 470 is passed through a hole 464 in base member 414 and through structure 472, being secured in place by a nut 474. A washer 473 under bolt head 471 bears against an upper surface 415 of base member 414.

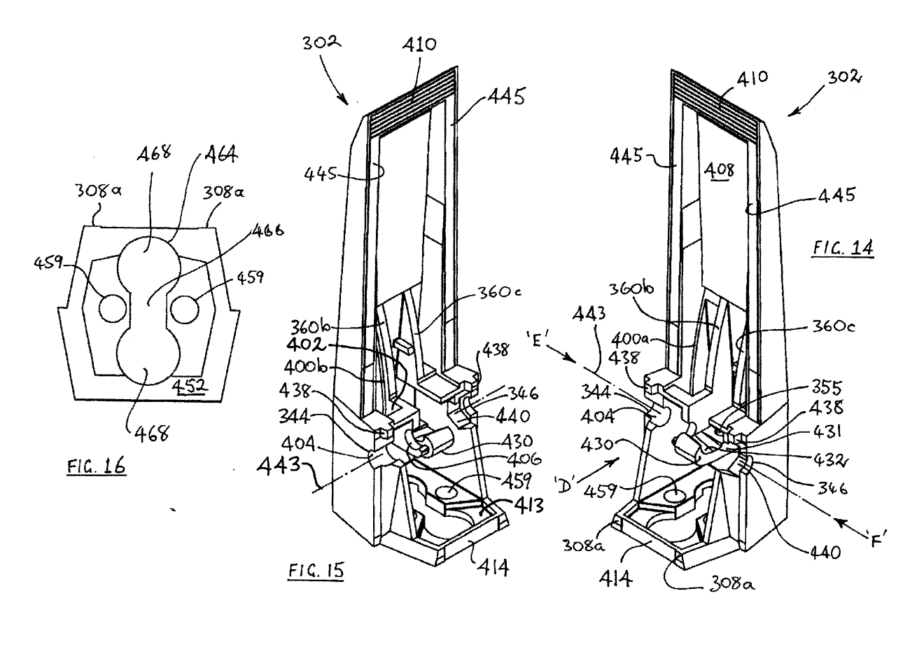

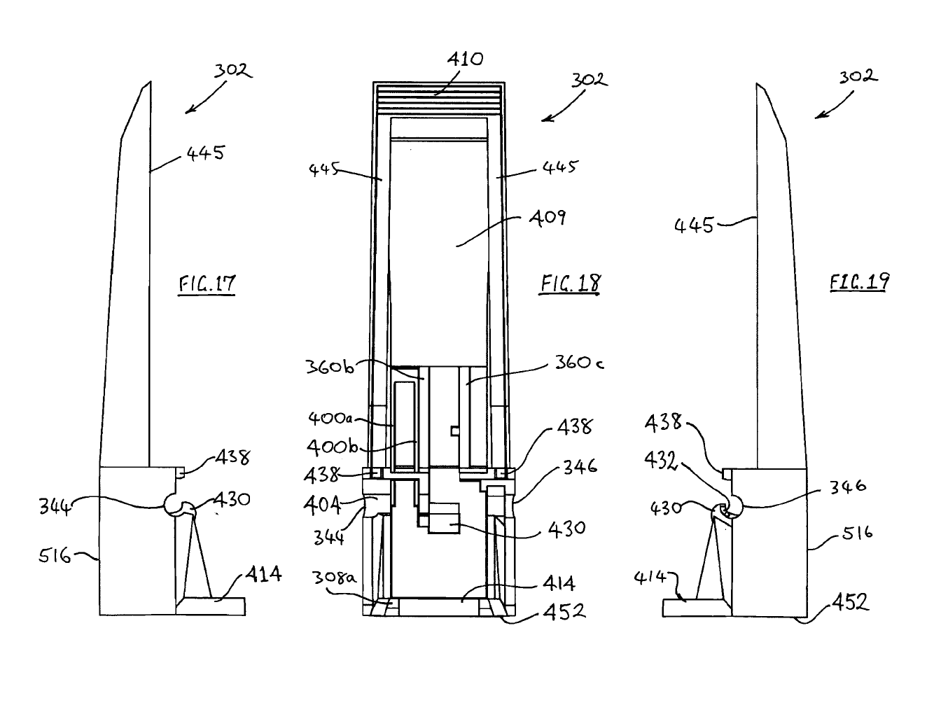

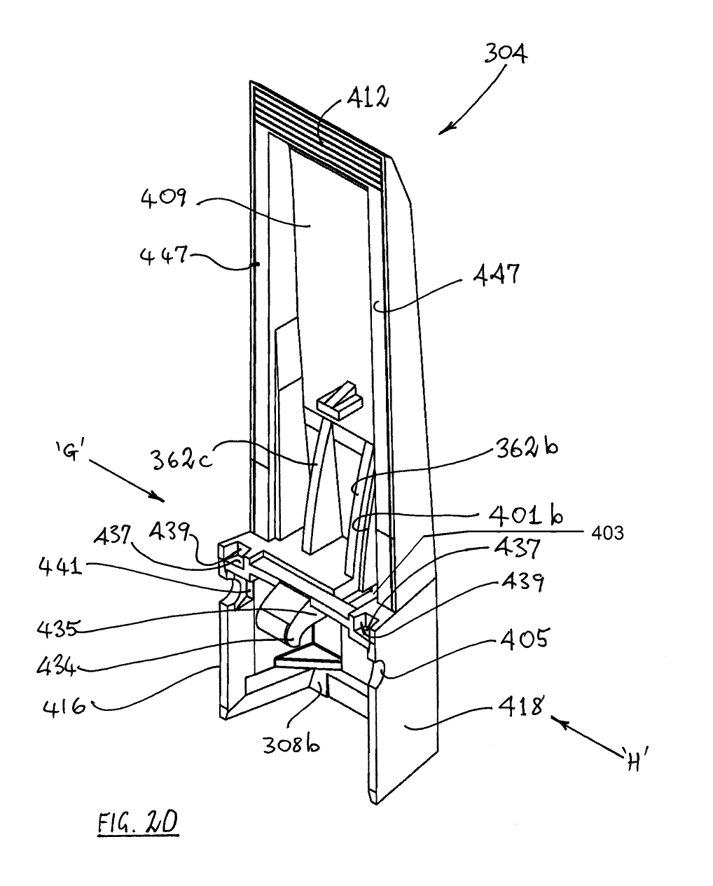

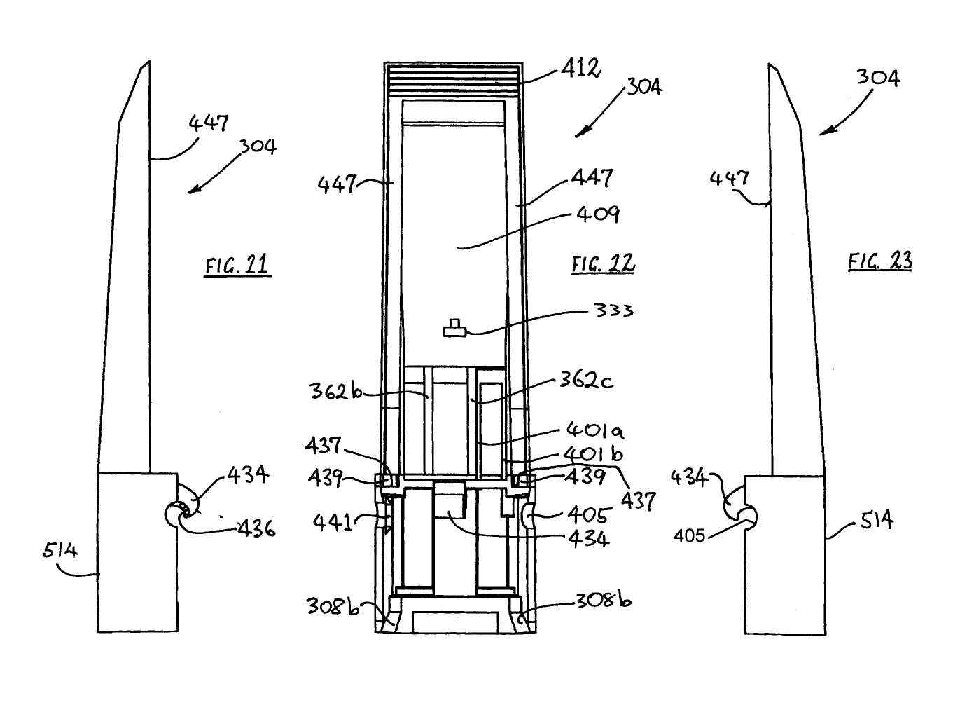

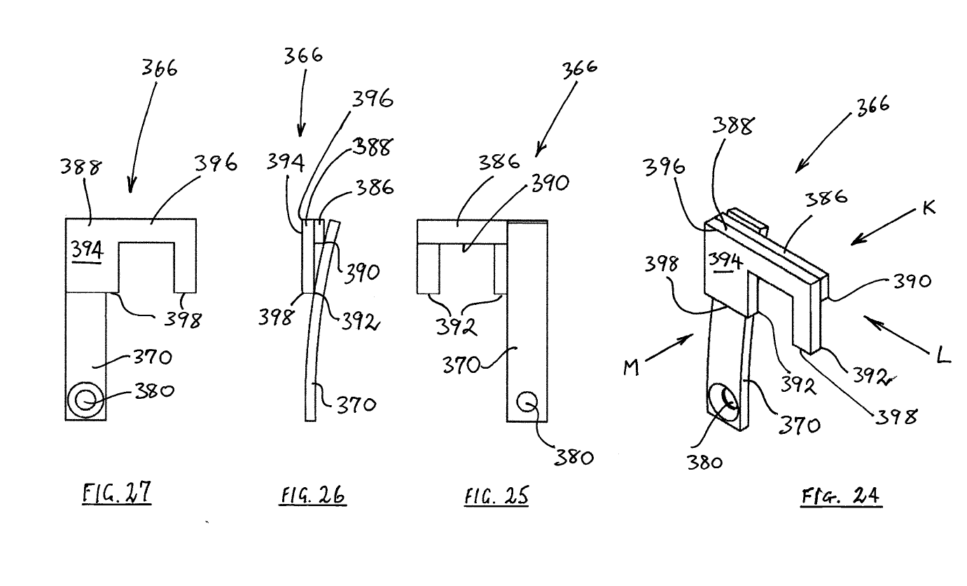

Hole 464 is elongate as shown in FIG. 16, so that the assembled clamp 300 can be moved laterally relative to bolt 470 before nut 470 is tightened. This adds a further adjustment (in addition to panel tilt and height) to assist the user. (Note that detail visible through hole 464 has been omitted for clarity in FIG. 16.)

An alternative to the arrangement shown in FIG. 34 (not shown) is to provide a threaded hole in the structure or member to which the clamp 300 is to be mounted, with a bolt being used in the same place and way as bolt 470, but in this case threadably engaged with the threaded hole in the structure.

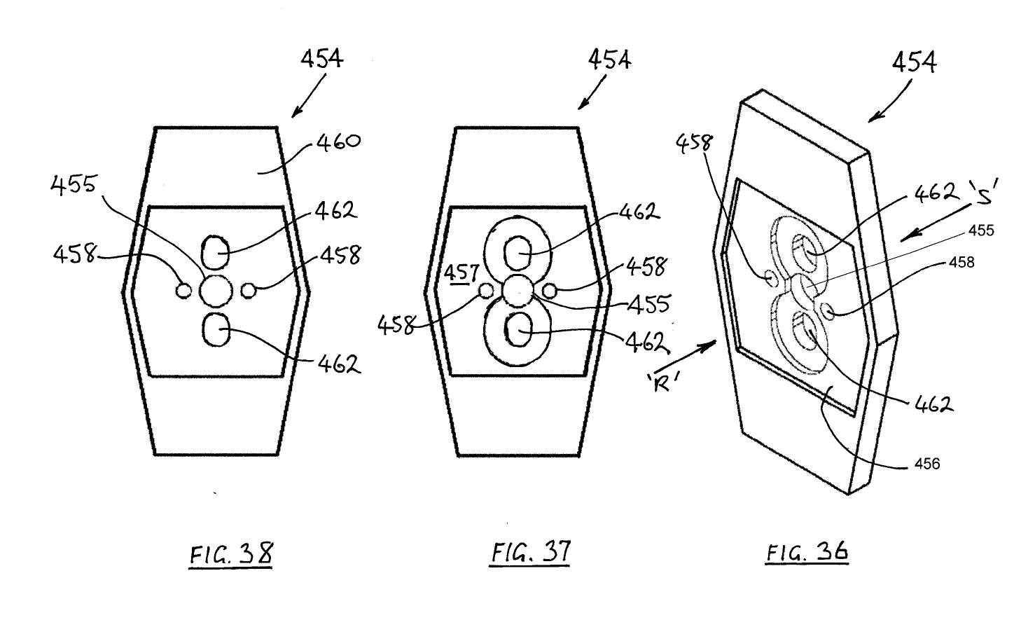

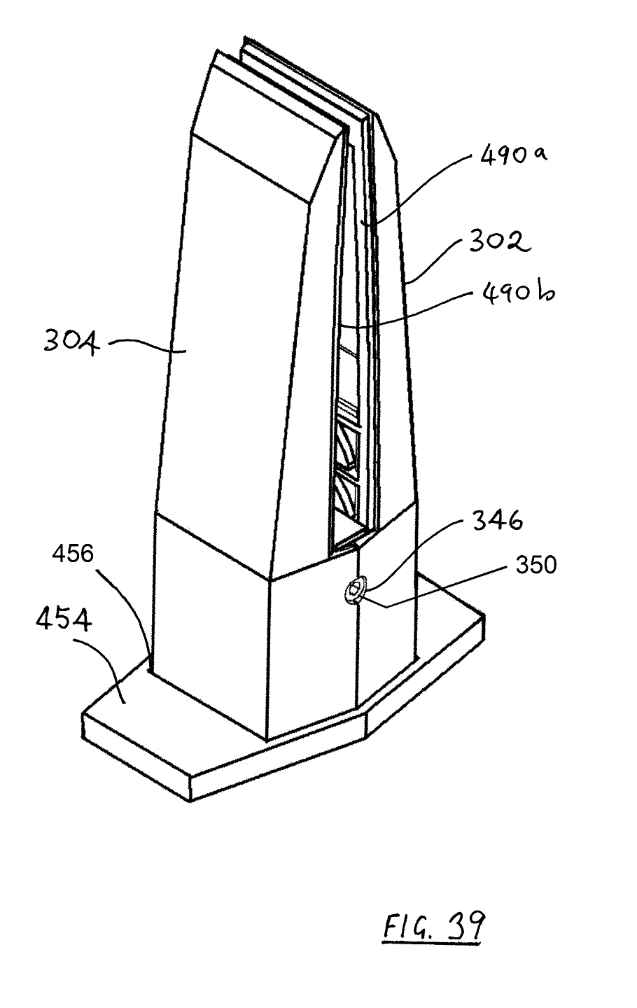

However, some structures, such as timber decks, may be of insufficient rigidity to withstand the forces transmitted into them by the clamp 300 when the above mounting arrangement is used. For mounting to such a structure, a baseplate 454 may be secured to clamp member 302 to provide a larger area of contact with the structure. Base plate 454 is shown in FIGS. 36 to 38 and clamp 300 mounted on baseplate 454 is shown in FIG. 39. In baseplate 454, a recess 456 is shaped and sized to receive the assembled clamp 300 with small peripheral clearance, and with bottom face 452 of clamp member 302 abutting an upwardly facing surface 457 inside recess 456. Within recess 456 are provided two threaded holes 458. Clamp member 302 has two clearance holes 459 (see FIG. 16) which when clamp 300 is received in recess 456 register with holes 458 in baseplate 454. High strength screws (not shown) can thus be used to secure baseplate 454 to clamp member 302, passing through holes 459 and being threadably engaged in holes 458. Bottom surface 460 of baseplate 454 has a larger area than face 452 on clamp 300, so that transmitted loads are better spread when clamp 300 is fitted with base plate 454.

Baseplate 454 has two slot-type holes 462 through each of which a bolt (not shown) can be passed, the heads (not shown) of these two bolts being received within hole 464 in base member 414 of clamp member 302. Hole 464 has a central slot 466 joining two round openings 468, large enough for the bolt heads to be received therein with clearance. The fact that holes 462 are elongated allows the clamp 300 when mounted via baseplate 454 to be moved laterally (i.e. perpendicularly to the length of panel 306 held in the clamp 300) before being finally secured firmly in place. Such an adjustment is a useful addition to the panel tilt and height adjustments provided by clamp member 300 itself. Alternatively, a single bolt (not shown) may be used, passing through a central hole 455 in baseplate 454.

Although baseplate 454 is shown as having a hexagonal shape, other suitable shapes are of course not precluded.

Another arrangement is suitable where for example it is desired to mount clamp 300 on a concrete slab 528 or the like. (For convenience, only a concrete slab 528 will be described, but this is not to preclude mounting to other forms of substrate.) Some prior art clamps (not shown) are mounted on concrete slabs by core-drilling or cutting a hole in the slab larger in diameter than the clamp's largest transverse dimension, placing a lower portion of the clamp in the hole and then placing grout around that lower portion to secure the clamp in the hole. The result can be unsightly and often a decorative collar (not shown) is placed around the clamp at the slab surface to hide the grout. This is unnecessary for clamp 300, when mounted as described next.

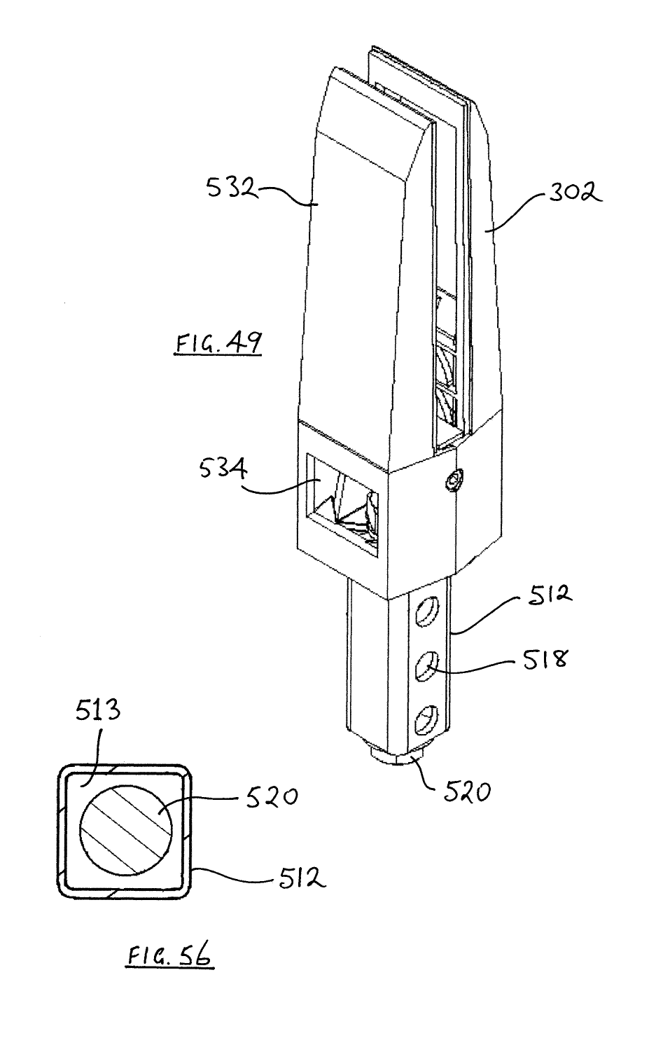

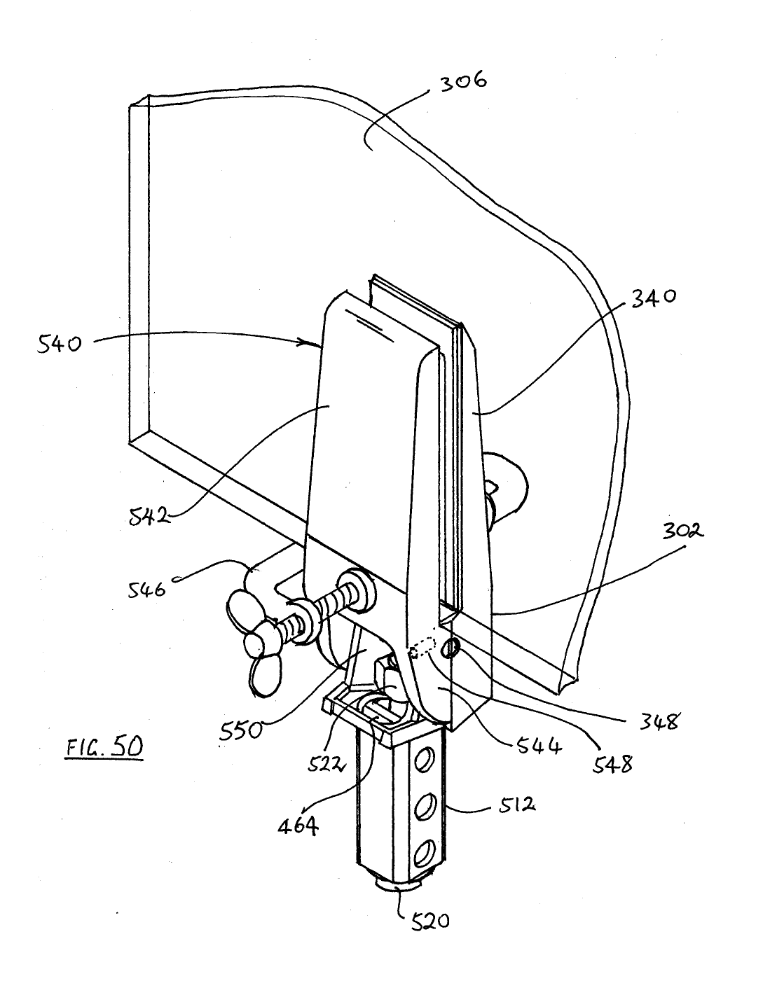

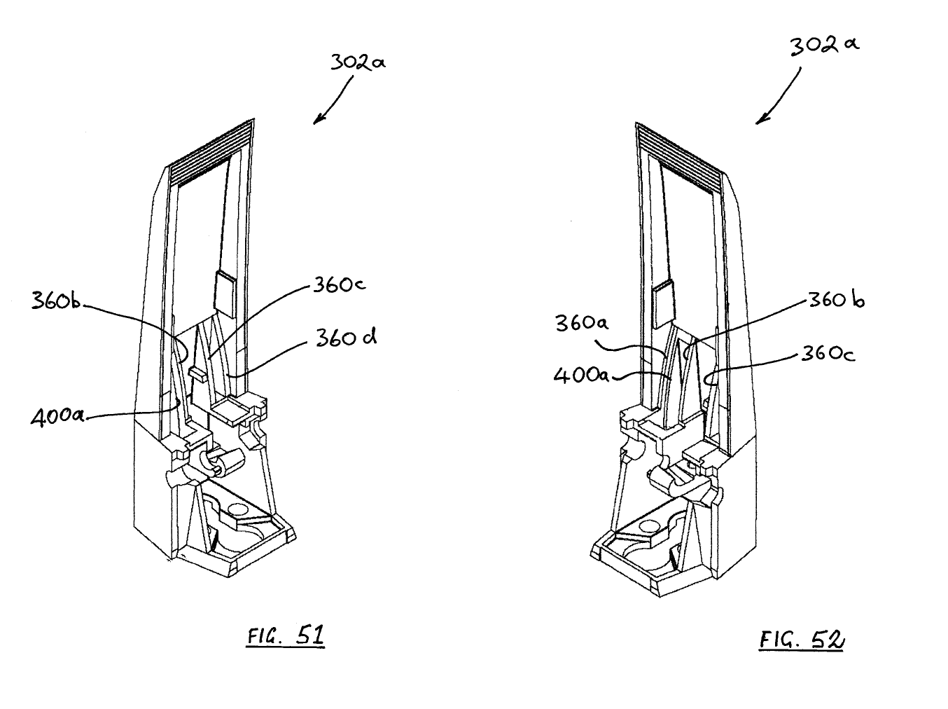

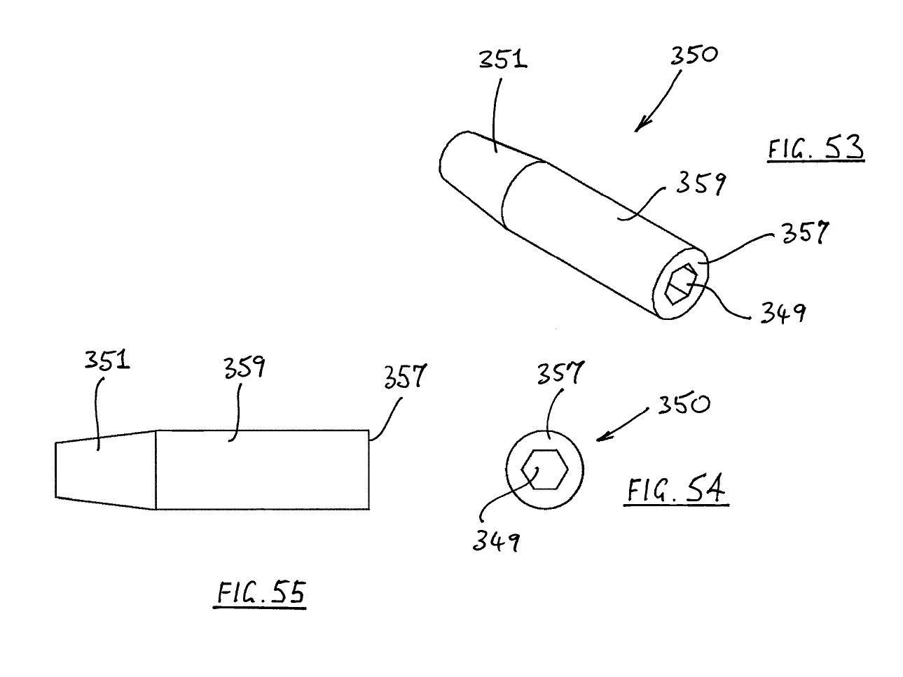

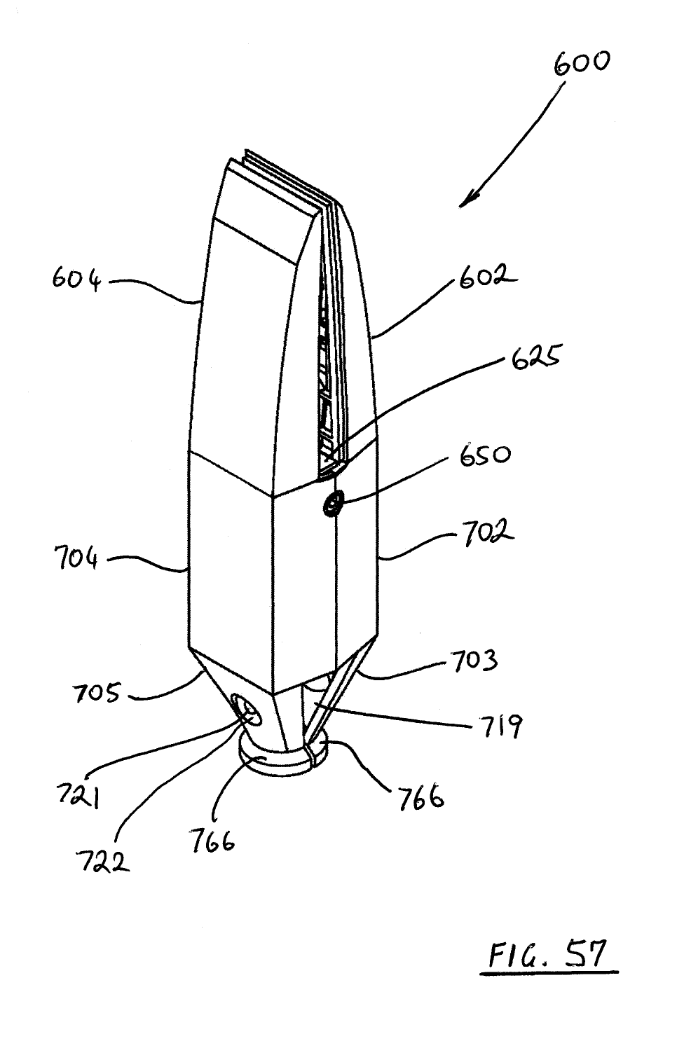

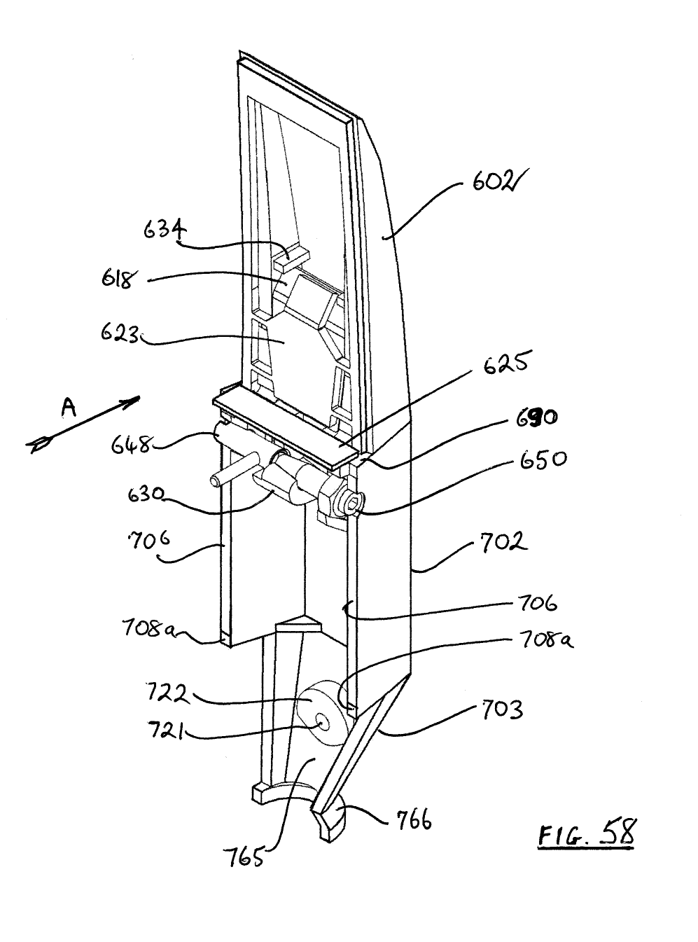

FIG. 46 shows clamp 300 fitted with an anchor 512 that can be grouted into a hole 526 cut into a slab 528. FIG. 56 shows anchor 512 in cross-section. Note that anchor 512 is smaller in its maximum width than the smallest transverse dimension of the clamp 300 (between opposite faces 514 and 516), so hole 526 can be smaller in diameter than in the conventional approach mentioned above. Anchor 512 is elongate and hollow and provided with several holes 518, and is held in place against the base member 414 of clamp member 302 by a tension member, in this case a bolt 520. Bolt 520 passes through an internal space 513 in anchor 512 and through hole 464 and engages a nut 522 secured above upper surface 415 of base member 414. In FIG. 46, only three holes 518 are shown. However, more may be provided, and in particular more holes (not visible in FIG. 46) are provided on the opposite side of anchor 512 from holes 518. FIG. 47 shows clamp member 302 with anchor 512 attached ready for grouting in place. FIG. 48 shows clamp 300 positioned in hole 526 and against a surface 530 of slab 528. The grout is not shown in FIG. 48, but would fill hole 526, and the internal space 513 up the level of surface 530 of slab 528.

To provide clamp 300 secured to slab 528 in this way, hole 526 is first core-drilled or cut. Then clamp member 302, with bolt 520 and nut 522 secured thereto, is positioned on surface 530, with anchor 512 in hole 526. Grout (for example of cementitious type) or settable adhesive (for example of epoxy type) is then poured or injected through both openings 468 of hole 464, and flows downward into hole 526 and into space 513 between bolt 520 and anchor 512, these spaces communicating with each other through holes 518. The shape of hole 464 (see above, with reference to FIGS. 16 and 36 to 38) permits such grout or adhesive movement, and a recess 413 in base member 414 assists in controlling the flow. When clamp member 302 is satisfactorily secured in place, clamp member 304 and the other parts of clamp 300 are assembled to clamp member 302 to complete the installation.

Note that the particular cross sectional shape of anchor 512 shown in FIG. 56 is not essential. Other suitable shapes may be used.

It is desirable to position the clamp member 302 correctly before grouting, and doing so can limit any need to rely on the panel tilt adjustment to correct any inaccuracies. For this purpose, the step of grouting may also be facilitated by temporarily assembling clamp 300 using instead of clamp member 304 a “dummy” clamp member 532, shown in FIG. 49, that is in all essentials the same as clamp member 304 except for provision of an opening 534 for grout or adhesive to be introduced by an installer. Ideally, the panel 306 is actually clamped between clamp member 302 and dummy clamp member 532, so that it can be correctly positioned. Once the panel 306 is correctly positioned and temporarily supported, clamp member 302 is grouted into position, the grout being introduced through opening 534. Once the grout has set, dummy clamp member 532 and panel 306 can be removed, and the real clamp member 304 can be secured to clamp member 302 together with the internal parts of clamp 300 to complete the installation of clamp 300. Panel 306 is then installed in clamp 300.

FIG. 50 shows an alternative embodiment of “dummy” clamp member 532, which has the advantages of simplicity and easier access for placement of grout or adhesive. Clamp member 540 has an upper portion 542 and a lower portion 544 and can be held by a conventional “G” clamp 546 with lower portion 544 in co-operating abutment with clamp member 302 and with upper portion 542 against panel 306, so as to clamp panel 306 between upper portion 542 and upper portion 340 of clamp member 302. Upper portion 542 is shaped and resiliently padded to be equivalent in its action on panel 306 to the upper portion 342 of clamp member 304 and clamping assembly 365 in combination, when clamping assembly 365 is in the position shown in FIG. 9, when the lower portion 544 is in co-operating abutment with clamp member 302. Panel tilt adjuster 348 is held between clamp members 302 and 540 just as it is between clamp members 302 and 304, except that spoke 378 of panel tilt adjuster 348 is received in a female recess 548 in lower portion 544 that is oriented to maintain tilt adjuster 348 in the position shown in FIG. 12. (Recess 548 is shown in dotted lines.) Thus, panel 306 is held by clamp members 302 and 540 with clamp member 302 in the same position relative to panel 306 as it would be in clamp 300 when adjusted as in FIGS. 9 and 12. (Note that unlike dummy clamp member 532, clamp member 540 does not have a movable clamping assembly equivalent to clamping assembly 365.)

Lower portion 544 has a cutaway area 550 that allows access to nut 522 and to hole 464 for grout placement.

In use, clamp members 540 and 302 (302 with anchor 512 attached) are secured to panel 306, and it can then be correctly positioned and propped in place by an installer, and the grouting process carried out to secure anchor 512 in place. Then clamp 546, clamp member 540 and panel 306 are removed, and clamp member 304 assembled to clamp member 302 and the remaining parts of clamp 300. Finally, panel 306 is placed in the completed clamp 300, its tilt adjustment used to correct any misalignment as and if required, and clamp 300 fully tightened on panel 306.

As an alternative to direct mounting of clamp 300 against slab surface 530, clamp member 302 may be firstly secured to base plate 454, as described above, anchor 512 installed as before, and then this assembly grouted in place in essentially one of the same ways as described above, grout or adhesive in this case passing downward through holes 462 of base plate 454.

As still another alternative, a conventional expanding bolt anchor (not shown) may be installed in a hole (not shown) cut in slab 528 so that clamp 300 (with or without base plate 454) can be secured by a bolt (not shown) received in the bolt anchor. (Where the base plate is used, two such bolt anchors may be used, with bolts passing through holes 462.)

Yet another possibility (not shown) is to grout a threaded member (such as a bolt) into a hole such as hole 526 so that the threaded member protrudes above surface 530 and can then be used to secure clamp member 302 in place, again with or with without baseplate 454. (Two threaded members can be used if the baseplate 454 is used, passing through holes 462.)

A yet further possibility (not shown) is to bolt clamp member 302 in place directly with a concrete bolt, i.e. a bolt that is simply screwed down into a pilot hole in the concrete slab 528. Where the baseplate 454 is used, two such concrete bolts may be used, passing through holes 462.

It will be noted that all of the mounting methods described above allow removal or repositioning of the clamp 300 after installation, if required.

The methods described above for mounting clamp 300 to a slab 528 or like structure are all conveniently possible because clamp member 302 has a cavity 541 above base member 414 for fasteners or fastener parts to be received and then hidden when clamp members 302 and 304 are assembled together.

The mounting arrangements and methods described above are considered as inventions in themselves, independently of the panel tilt adjustment capability.

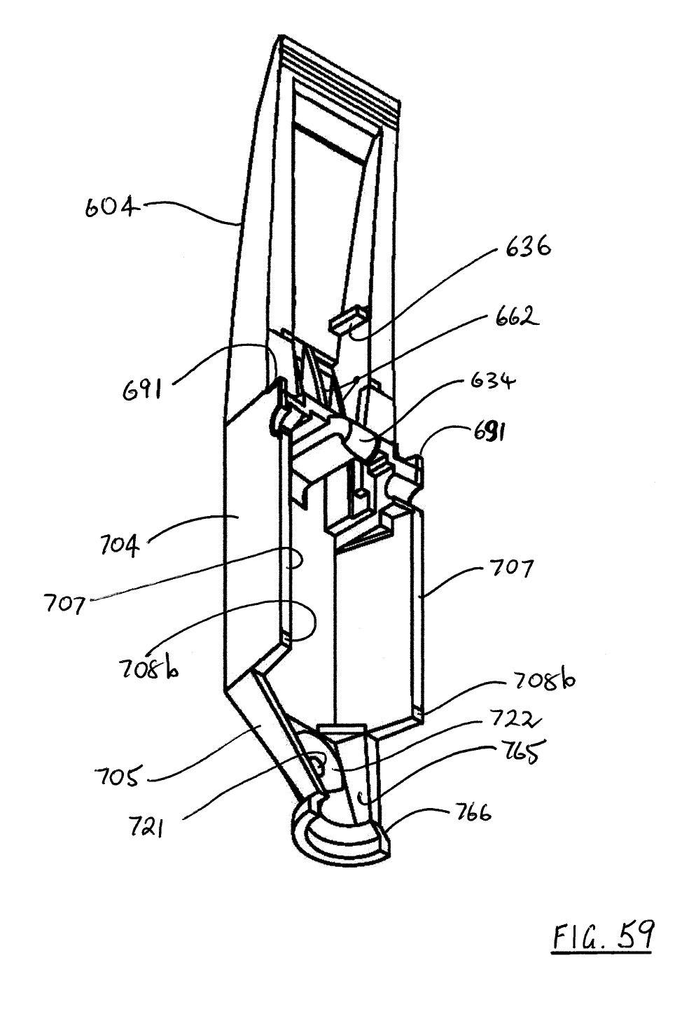

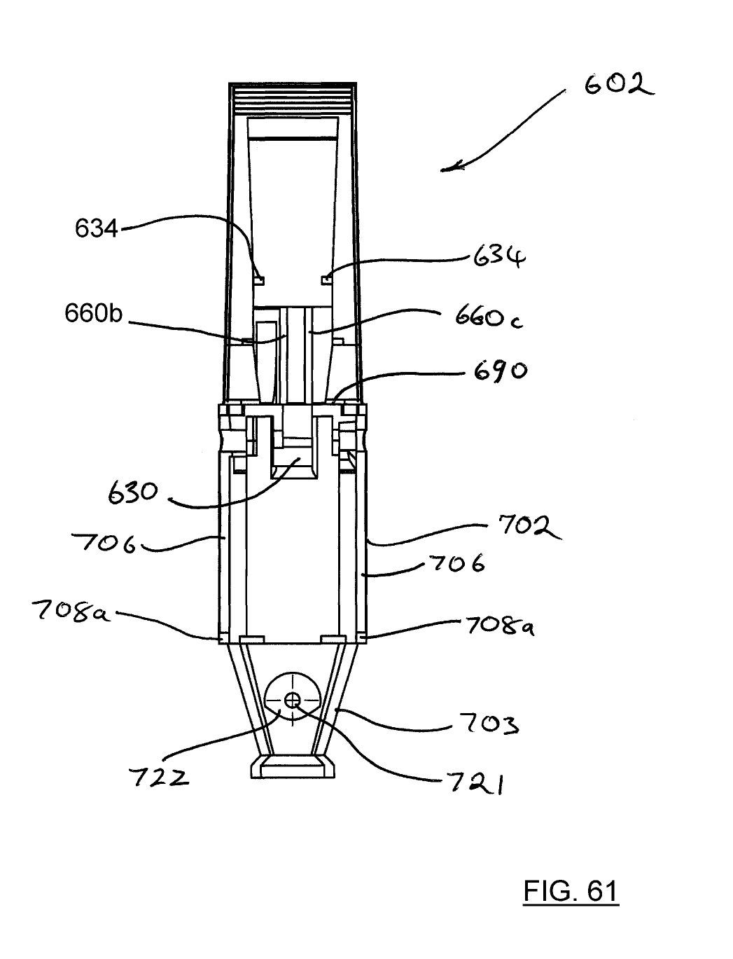

As mentioned above, some prior art clamps are able to be mounted directly in a concrete or other structure by being grouted into holes drilled or otherwise formed in that concrete structure. A further clamp 600, with panel tilt adjustment capability, that can be mounted in this way, will now be described, by reference to FIGS. 57 to 61. For convenience of description below, in particular for interpretation of orientation-dependent words such as “upper” and “lower”, the assembled clamp will be assumed to be oriented as it would be when used to support a panel 606 in a vertical plane, by its horizontal lower edge 750, above a horizontal surface 752 of a concrete structure 754.

Clamp 600 clamps a panel 606, and allows the tilt of panel 606 to be adjusted, in the same way as clamp 300 clamps panel 306 and allows its tilt to be adjusted. The main components of clamp 600 are first clamp member 602 and second clamp member 604, which correspond in their functions to first and second clamp members 302 and 304, respectively, of clamp 300. The explanation above of the way in which clamp 300 is assembled and in which it clamps and allows tilt adjustment of panel 306, and the components by which this is realized, are equally applicable to clamp 600 and its clamping of panel 606, and so need not be repeated here. Clamp 600 has a panel tilt adjuster 648 the same as, and operating in the same way as, tilt adjuster 348 of clamp 300.

Also, clamp 600 has a clamping screw 650 the same as clamping screw 350 of clamp 300. Clamping screw 650 can be used to draw clamp members 602 and 604 together so as to clamp panel 606 therebetween by the same mechanism as described above in respect of clamp 300 and its clamping screw 350. This mechanism will also therefore not be described again here.

Clamp 600 may be provided with panel height adjustment in the same way as clamp 300. Preferably, however, the panel height adjustment facility of clamp 300 is omitted. To achieve this, clamp 600 has no equivalents of ledge 320, pad 321, screw 534 and nuts 356. Clamping plate 618 and a resilient pad 623 are provided, that do what clamping plate 318 and pad 323 do in clamp 300, for clamping and tilt adjustment, but do not have a ledge and pad equivalent to ledge 320 and pad 321. Instead, in clamp 600 the lower edge 750 of clamped panel 606 is supported on a resilient pad 625 that abuts upwardly facing surfaces 690 and 691 of clamp members 602 and 604. Excessive upward movement of clamping plate 618 is limited by stops 634 in clamp member 602. Stops 636 of clamp member 604 serve the same purpose as stop 333 in clamp member 304. (Note that resilient pad 623 is shown with an optional slightly different shape from pad 323 of clamp 300.)

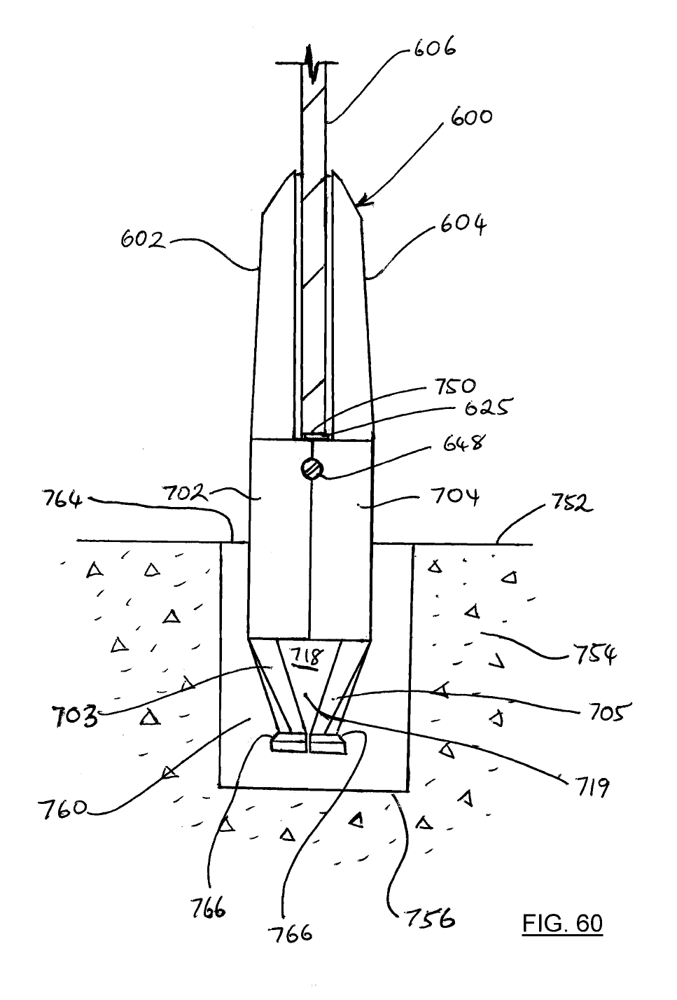

The reason why the panel height adjusting facility can be omitted from clamp 600 is as follows. In normal installation practice (leading to the result shown in FIG. 60) clamps 600 can firstly be secured to panel 606, the panel then being temporarily supported at the desired height above surface 752 with the clamps 600 received in holes 756 in the underlying concrete structure 754, holes 756 being sized to receive with clearance intermediate and lower portions 702, 703, 704 and 705. Then holes 756 are filled with grout 760 to secure clamps 600 in place. In this scenario, no height adjustment is necessary. Nevertheless, this is not intended to preclude the possibility of providing, as a still further embodiment of the invention, a clamp (not shown) the same as clamp 600 except having a panel height adjustment facility, as described for clamp 300.

Below the positions of tilt adjuster 648 and clamping screw 650, first clamp member 602 comprises an intermediate portion 702 and a lower portion 703, and second clamp member 604 comprises an intermediate portion 704 and a lower portion 705. In assembled clamp 600, edge surfaces 706 and 707 of intermediate portions 702 and 704 face each other. Surfaces 708a and 708b abut each other and have the same function in clamp 600 as surfaces 308a and 308b on clamp 300. That is, they provide a fulcrum about which clamp members 602 and 604 rotate very slightly while being progressively pressed against panel 606 therebetween during the clamping process.

Lower portions 703 and 705 of clamp members 602 and 604 provide an anchoring effect when clamp 600 is grouted into a hole. More particularly they function as anchoring formations having upwardly facing surfaces (eg 765, 766) whereby after grouting clamp 600 cannot be dislodged from hole 756 by simply lifting it upwardly without actual fracturing of the grout 760. Note that the shapes of lower portions 703 and 705 provide openings 719 through which in assembled clamp 600 the settable grout 760 (in the form of a thick liquid or slurry) being poured into hole 756 can enter a cavity 718 defined by and lying between the intermediate portions 702 and 704 and lower portions 703 and 705. Once grouted in place, that part of clamp 600 above the grout surface 764 has substantially the external appearance of clamp 300 as shown in FIG. 4. Slurry entering cavity 718 can fill it to the level of the grout surface 764 outside clamp 600, so helping to limit ingress of moisture into the hole 756 and concrete mass 754.

Of course, like clamp 300, clamp 600 may have other external appearances and shapes, consistent with their functioning in the ways described herein.

Provision may be made for electrical earthing of clamp 600 where this is desirable, or required. Thus, lower portions 703 and 705 have holes 721 with surrounding lands 722 whereby screws and nuts (not shown) can be used to secure earthing wires (not shown) to clamp 600.

A problem that can arise, albeit rarely, is breakage of a panel such as panel 606, so that a replacement must be fitted. Where the whole lower end of a clamp is grouted in place, as shown for clamp 600 in FIG. 60, this can be difficult. A solution is to provide a clamp in which there are two clamp members (corresponding in function, for example, to clamp members 602 and 604 of clamp 600) but only one is permanently grouted in place, the other remaining removable or at least movable in place to enable release of a broken panel. This is the approach followed in clamp 800, described below.

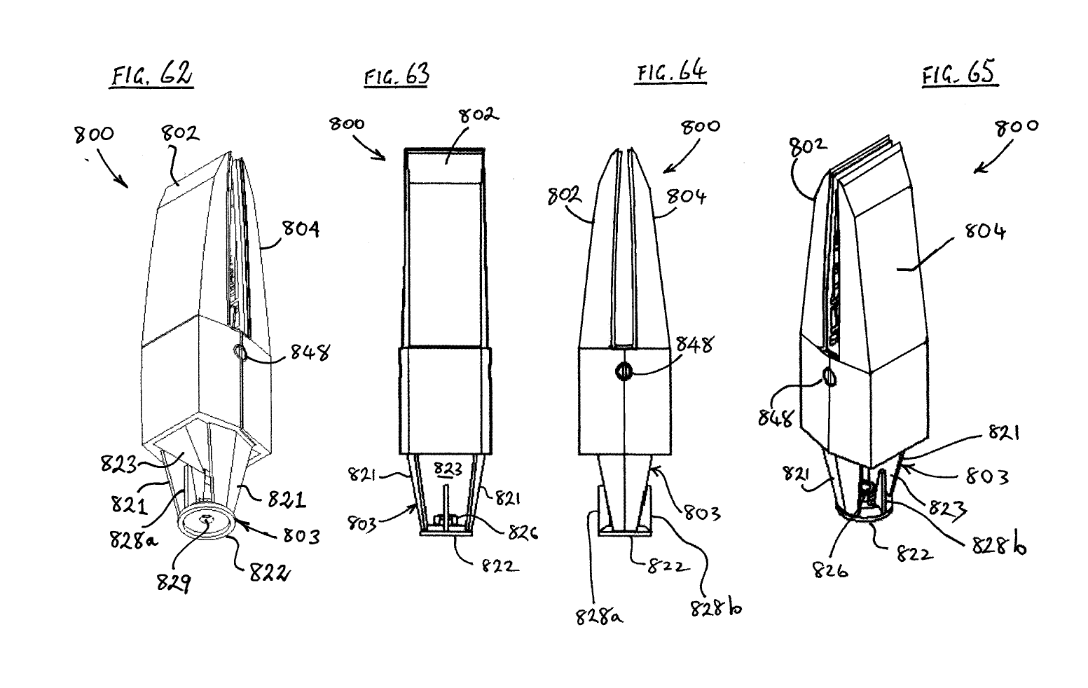

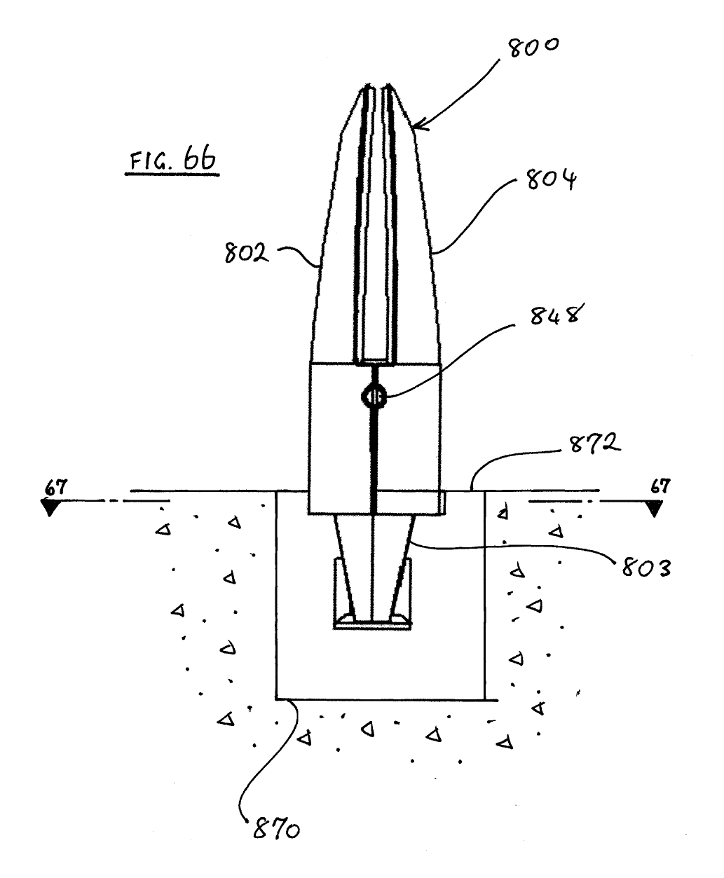

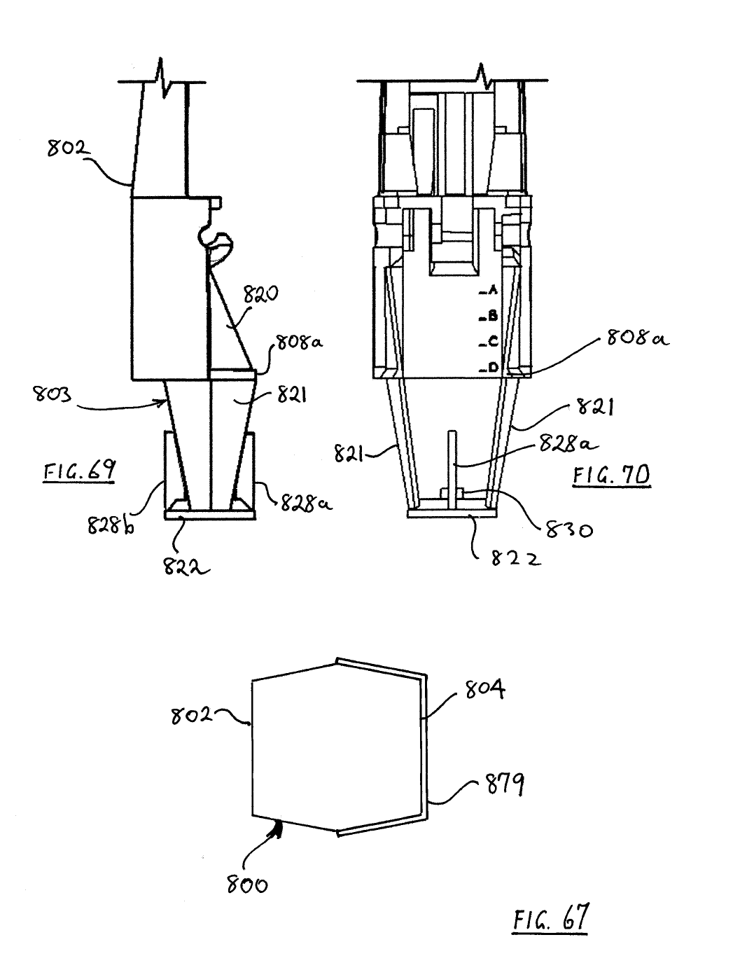

FIGS. 62 to 65 show further clamp 800 which may be grouted into a hole 870 so as to protrude above a surface 872 as shown in FIG. 66. Clamp 800 is identical in its clamping and tilt adjustment mechanisms to clamps 300 and 600 so that these mechanisms need not be described again here. As with clamp 600, panel height adjustment may be provided or omitted as desired. Corresponding in function to clamp members 602 and 604 of clamp 600 (and clamp members 302 and 304 of clamp 300) clamp 800 comprises first and second clamp members 802 and 804 respectively. Also visible in FIGS. 62 and 64 is a tilt adjuster 848, which corresponds in function to tilt adjuster 348. There is also provided (but not shown in FIGS. 62-66 being located on the opposite side of clamp 800 from tilt adjuster 848) a clamping screw 850 corresponding to clamping screw 350 of clamp 300.

Clamp 800 has a single anchor formation 803, comprised in clamp member 802, which can be firmly retained in hole 870 by grout 825. Clamp member 804 has no corresponding anchor formation, and is able to be disassembled (or simply loosened) from clamp member 802 when required for replacement of a broken panel (not shown). Anchoring formation 803 comprises gussets 820 and, depending therefrom, webs 821. Webs 821 in turn terminate in a bottom plate 822. Spaces 823 are left between webs 821 so that grout 825, when poured into hole 870 can enter the interior of clamp 800, for example up to the level of surface 872 to help prevent damage to the installation due to water ingress. However, it is emphasized that the particular form of anchor formation 803 is not essential. Other suitable shapes may be used that when grouted in to hole 870 as in FIG. 66 provide firm restraint against movement.

Clamp member 804 is the in its essentials the same as clamp member 304, and that part of clamp member 802 above anchor formation 803 is in its essentials the same as clamp member 302 (except for gussets 820) so that clamp members 802 and 804 mate and cooperate in the same way as clamp members 302 and 304. Surfaces 808a correspond in function to surfaces 308a of clamp member 302.

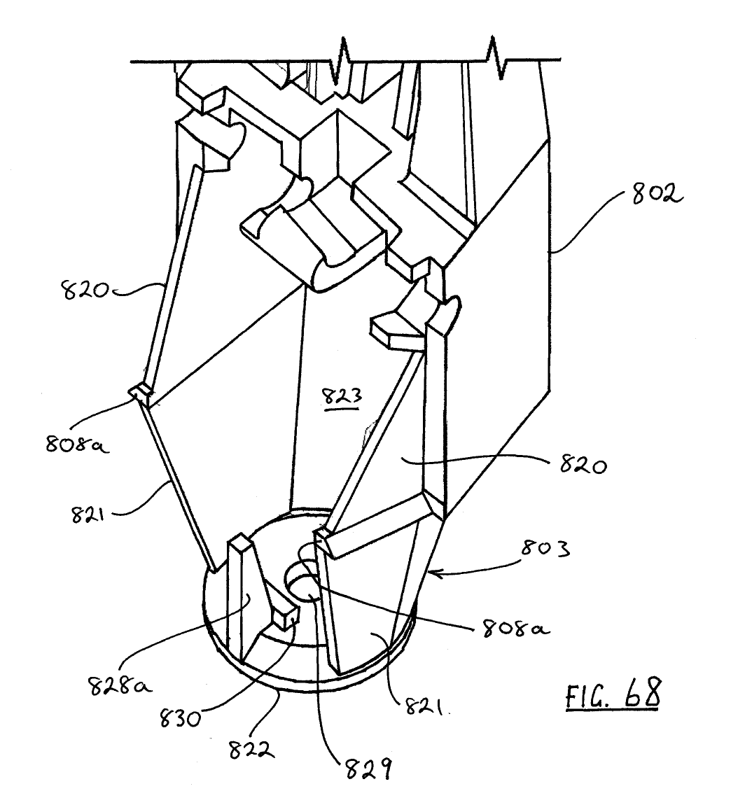

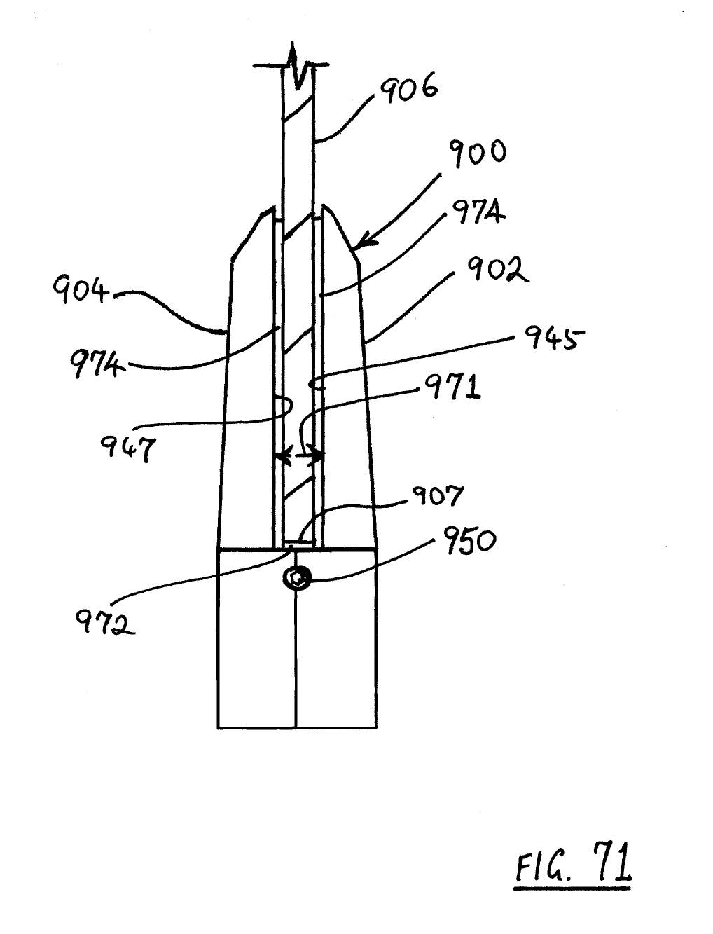

Clamp 800 is positioned and grouted in place in hole 870 with a panel (not shown) clamped therein, in the same way as described above for clamp 600, with the following exception. Before grout 825 is placed, a membrane 879 of soft flexible material, such as for example a closed-cell plastics foam or natural or synthetic rubber, is secured by adhesive to the exterior of that part of clamp member 804 that is to lie below surface 852. This allows the small relative movement of clamp members 804 and 802 during clamping and unclamping to occur, without damage to grout 825, when clamp member 804 is loosened (by loosening clamping screw 850) from clamp member 802 to allow removal and replacement of a broken panel. Once the new panel is positioned between clamp members 802 and 804 the clamp 800 can be re-tightened, with tilt adjustment if necessary. The depth to which clamp member 804 lies below surface 872 is chosen during initial installation according to the application. Guide marks for this depth are shown in FIG. 70 and labelled “A” to “D”.

Bottom plate 822 of anchor formation has a hole 829 for attachment by a bolt (not shown) and nut 826 (shown in position in the Figures) of an additional anchor formation (not shown). This may sometimes be required to increase resistance to clamp movement against loads applied to clamp 800 through a panel therein. A formation 830 is provided to prevent rotation of nut 826 when nut 826 is in use.

Also, extending upwards from bottom plate 822 are two projections 828 which are useful in the erection of fences (such as fence 100 shown in FIG. 1) using clamps 800 as the clamps 104. Using fence 100 as an example, clamps 800 would be secured in place on panels 102 and the panels 102 then positioned and aligned accurately above ground mass 106 ready for marking on the ground mass 106 where the holes (corresponding to holes 870 in FIG. 66) that receive clamps 800 are to be drilled. A string (not shown) could be tied to one projection 828a on an endmost clamp 800, passed around the other projection 828b on that clamp and then extended past all the brackets 800 over the fence length to the clamp 800 at the other end of the fence 100, passed around the second-side projection 828b of that other clamp 800 and finally tied to the first-side projection 828a of that other clamp 800. Then, those clamps 800 between the two endmost clamps 800 can be accurately positioned relative to the string, using their projections 828b, and with this done, the hole positions accurately marked for drilling. (Here it has been assumed that all of the clamps 800 to be aligned are oriented with their projections 828b on the same side of the fence.)

The arrangement disclosed above, by which pairs of clamp members (such as 302 and 304 of clamp 300, 602 and 604 of clamp 600, and 802 and 804 of clamp 800) are held in clamping relationship with a panel is advantageous in itself, even if no panel tilt adjustment facility is provided. FIG. 71 shows in an upright position, a clamp 900 in which there is no panel tilt adjustment facility, clamp 900 having clamp members 902 and 904, gripping a panel 906 therebetween. Clamp members 902 and 904 are identical to clamp members 300 and 302 of clamp 300 except in two respects. Firstly, in use of clamp 900 to clamp panel 906, gap 971 between edge surfaces 945 and 947 of clamp members 902 and 904 respectively (corresponding to edge surfaces 445 and 447 in clamp 300) varies less between their upper and lower ends than the corresponding gap between surfaces 445 and 447 in clamp 300, which is wider at its lower end to accommodate the tilt adjustment. Secondly, those features of clamp members 902 and 904 needed for tilt adjustment may be omitted—for example the ramps 360 and 362 are unnecessary.

Also omitted from clamp 900 are components required for panel tilt and height adjustment, such as those shown in FIG. 32. The lower edge 907 of panel 906 is supported by a resilient pad 972 and resilient pads 974 of the same general form as pad 480a are provided between panel 906 and surfaces 945 and 947.

However, in clamp 900 the same arrangement is provided for drawing and holding clamp members 902 and 904 together as in clamp 300. Specifically, there is a clamping screw 950 the same as, and corresponding to, clamping screw 350, a captive nut (not shown) that does in clamp 900 what nut 358 does in clamp 300, and hooks (not shown) in essence the same as, and corresponding to, hooks 430 and 434. Screw 950 is positioned similarly to screw 350 in clamp 300, i.e. aligned parallel to and below (when clamp 900 is upright) the panel edge 907, so as to be advantageously unobtrusive compared to many prior art clamps.

Clamp 900 may be provided with any of the mounting arrangements described above in relation to clamps 300, 600 and 800.

It is even possible to provide a still further clamp (not shown) in which the above arrangements for drawing together and holding two clamp members are duplicated. Such clamp would be generally the same as clamp 900 except for having a second clamping screw (not shown) the same as screw 950 accessible from a position on the opposite side of the clamp from the first. To secure a panel in such a clamp, the two clamping screws would be screwed inward from opposite directions, both parallel to the clamped panel's edge.

Many other variations of the inventions disclosed herein will suggest themselves to the skilled person. One example is shown in FIG. 33, in which the components shown in FIG. 32 are shown in an identical view save that sliders 366a and 368a have the same proportions and functions as sliders 366 and 368 of clamp 300, but are made as single items rather than fabricated from several parts. Suitable manufacturing methods for sliders 366a and 368a could be investment casting or powder metallurgy.

It is possible to provide more ramps 360 for the slider 366 (or a slightly wider version thereof (not shown)) than the two ramps 360b and 360c shown in FIGS. 14 15 and 18. FIGS. 51 and 52 show a clamp member 302a that is functionally the same as clamp member 302, but has four ramps 360a, 360b, 360c and 360d. The two-ramp clamp member 302 has been found satisfactory and can be made stiffer and stronger for given external dimensions. In a similar manner, although not shown, an alternative version of clamp member 304 can be made with four ramps for the slider 368 or a slightly wider version thereof (not shown).

1-21. (canceled)

22. A clamp securable to a panel at an edge thereof and comprising:
a first clamp member;
a second clamp member;
a connecting means;
a first clamping assembly
a second clamping assembly
wherein:
in use a first portion of a panel is positioned between the first and second clamping assemblies and a second portion of the panel is positioned between the first and second clamp members;
the first and second clamping assemblies and the first portion of the panel therebetween are held between the first and second clamp members so that when the connecting means draws first and second clamp members towards each other, the first portion of the panel is held between the first and second clamping assemblies;
the first and second clamping assemblies are movable relative to the first and second clamp members in lateral directions approximately perpendicular to the panel,
so that the first portion of the panel is movable in said lateral directions relative to the second portion of the panel and the panel is tiltable relative to the clamp.

23. A clamp according to claim 2 comprising a panel tilt adjuster adapted to move the first and second clamping assemblies in the same lateral directions simultaneously when actuated by a user.

24. A clamp according to claim 23 further comprising:
a first slider between the first clamp member and the first clamping assembly which is movable so as to move the first clamping assembly laterally relative to the first clamp member;
a second slider between the second clamp member and the second clamping assembly which is movable so as to move the second clamping assembly laterally relative to the second clamp member; and
said panel tilt adjuster moves said sliders when actuated by a user.

25. A clamp according to claim 24 wherein said first and second sliders when moved by said panel tilt adjuster slide on ramps comprised in the first and second clamp members respectively, whereby to move the first and second sliders laterally.

26. A clamp according to claim 24 wherein said panel tilt adjuster comprises a shaft accessible and rotatable by a user so as to move said first and second sliders.

27. A clamp according to claim 26 wherein the shaft is accessible through a port that when the clamp is secured on a horizontal surface is under the said edge of the panel.

28. A clamp according to claim 26 wherein said shaft is rotatable about an axis substantially parallel to the said edge of the panel.

29. A clamp according to claim 22 wherein said first clamping assembly can bear against the edge of the panel and is movable in a direction that is substantially perpendicular to the lateral directions and the said edge of the panel, independently of lateral movement of the first clamping assembly, whereby when the clamp is secured on a horizontal surface the height of the panel lower edge can be adjusted.

30. A clamp according to claim 29 wherein the first clamping assembly is threadably engaged by a screw that:
(a) is rotatable by a user to move the first clamping assembly in the said direction that is substantially perpendicular to the lateral directions and the said edge of the panel, and
(b) able to be supported against longitudinal movement relative to the first clamp member.

31. A clamp according to claim 22 wherein the connecting means comprises a clamping screw that:
(a) is accessible by a user; and
(b) has a tapered end movable by rotation of the clamping screw through a range of positions between first and second hooks comprised respectively in the first and second clamp members whereby to move throat surfaces of said hooks apart and so draw said first and second clamp members towards each other.

32. A clamp according to claim 31 wherein the clamping screw is rotatable within a nut that is held captive between the first and second clamp members.

33. A clamp according to claim 31 wherein the clamping screw is rotatable about an axis that is approximately parallel to the said edge of the panel.

34. A clamp according to claim 31 wherein the clamping screw is accessible through a port that when the clamp is secured on a horizontal surface lies under the said edge of the panel.

35. A clamp according to claim 22 wherein the connecting means lies between the said edge of the panel and mutually opposing contact surfaces of the first and second clamp members whereby the contact surfaces provide a fulcrum for relative rotation between the first and second clamp members as the connecting means is actuated by a user to clamp the panel.

36. A clamp according to claim 22 wherein the first and second clamping assemblies each comprise a resilient pad and wherein in use of the clamp each of said resilient pads bears against the panel.

37. A clamp according to claim 36 wherein the resilient pad secured to the first clamping assembly respectively is integrally formed with a resilient pad that is secured to the first clamp member.

38. A clamp according to claim 36 wherein the resilient pad secured to the second clamping assembly respectively is integrally formed with a resilient pad that is secured to the second clamp member.
